(19) United States
(12) Patent Application Publication
(10) Pub. No.: US 2018/0329604 A1
(43) Pub. Date: Nov. 15, 2018

(54) METHOD OF PROVIDING INFORMATION IN VIRTUAL SPACE, AND PROGRAM AND APPARATUS THEREFOR

(71) Applicant: COLOPL, Inc., Tokyo (JP)

(72) Inventors: Takashi NAKABO, Tokyo (JP); Kazuaki SAWAKI, Tokyo (JP)

(21) Appl. No.: 15/915,922

(22) Filed: Mar. 8, 2018

(30) Foreign Application Priority Data
Mar. 8, 2017 (JP) 2017-043769

(51) Int. Cl. G06F 3/0481; H04L 29/06; G06T 13/40; G02B 27/01

(52) U.S. Cl. CPC G06F 3/04815; G02B 27/017; G06T 13/40; H04L 67/38

(57) ABSTRACT

A method including defining a virtual space to be shared by a first user and a second user. The virtual space includes a first object, a viewpoint and first, second and third places. The method includes arranging a second avatar object at the first place. The method includes providing a field-of-view image to the first user in accordance with a position of the viewpoint. The method includes identifying a first direction from the second place to the first object. The method includes identifying a ratio of the second avatar included in a first field of view for a case in which the viewpoint is arranged at the second place. The method includes identifying the second place as a recommended place. The method includes displaying first information for identifying the recommended place in the field-of-view image.

### RELATED APPLICATIONS

The present application claims priority to Japanese Application No. 2017-043769, filed on Mar. 8, 2017, the disclosure of which is hereby incorporated by reference herein in its entirety.

### TECHNICAL FIELD

This disclosure relates to a technology for providing a virtual space, and more particularly, to a technology for providing information in a virtual space shared by two or more users.

### BACKGROUND

Hitherto, there has been provided a virtual space to be supplied to two or more users on a network. For example, in Japanese Patent Application Laid-open No. 2007-213453 (Patent Document 1), there is described a virtual space shared entertainment community generation system for “providing a virtual space shared entertainment community in which all registered users including those unfamiliar with the virtual community can easily understand how to enjoy the community and which can be freshly enjoyed over a long period of use”. This virtual space shared entertainment community generation system “includes a virtual space shared entertainment community content database server 11 and a virtual space shared entertainment community content file server 12, which each store content data and data of users registered in the virtual space shared entertainment community, and a virtual space shared entertainment community generation content server 10 including control means for issuing HTML tags for displaying character strings and images in the virtual space shared entertainment community” (see Abstract of Patent Document 1).

### PATENT DOCUMENTS

[Patent Document 1] JP 2007-213453 A

### SUMMARY

According to at least one embodiment of this disclosure, there is provided a method including defining a virtual space to be shared by a first user and a second user, the virtual space including a first object, a viewpoint, a first place, a second place, and a third place. The method further includes arranging a second avatar associated with the second user at the first place in accordance with a designation of the first place by the second user. The method further includes identifying a field of view in the virtual space based on a position of the viewpoint. The method further includes generating a field-of-view image in accordance with the field of view. The method further includes providing the field-of-view image to the first user. The method further includes identifying that the second avatar is not arranged at the second place and is not arranged at the third place. The method further includes identifying a first direction from the second place to the first object. The method further includes identifying a ratio of the second avatar included in a first field of view, which is identified based on the position of the viewpoint and the first direction, for a case in which the viewpoint is assumed to be arranged at the second place. The method further includes identifying that the ratio is equal to or less than a threshold. The method further includes identifying the second place as a recommended place. The method further includes displaying first information for identifying the recommended place in the field-of-view image.

### BRIEF DESCRIPTION OF THE DRAWINGS

FIG. 1 A diagram of a system including a head-mounted device (HMD) according to at least one embodiment of this disclosure.

FIG. 2 A block diagram of a hardware configuration of a computer according to at least one embodiment of this disclosure.

FIG. 3 A diagram of a uvw visual-field coordinate system to be set for an HMD according to at least one embodiment of this disclosure.

FIG. 4 A diagram of a mode of expressing a virtual space according to at least one embodiment of this disclosure.

FIG. 5 A diagram of a plan view of a head of a user wearing the HMD according to at least one embodiment of this disclosure.

FIG. 6 A diagram of a YZ cross section obtained by viewing a field-of-view region from an X direction in the virtual space according to at least one embodiment of this disclosure.

FIG. 7 A diagram of an XZ cross section obtained by viewing the field-of-view region from a Y direction in the virtual space according to at least one embodiment of this disclosure.

FIG. 8A A diagram of a schematic configuration of a controller according to at least one embodiment of this disclosure.

FIG. 8B A diagram of a coordinate system to be set for a hand of a user holding the controller according to at least one embodiment of this disclosure.

FIG. 9 A block diagram of a hardware configuration of a server according to at least one embodiment of this disclosure.

FIG. 10 A block diagram of a computer according to at least one embodiment of this disclosure.

FIG. 11 A sequence chart of processing to be executed by a system including an HMD set according to at least one embodiment of this disclosure.

FIG. 12A A schematic diagram of HMD systems of several users sharing the virtual space interact using a network according to at least one embodiment of this disclosure.

FIG. 12B A diagram of a field of view image of a HMD according to at least one embodiment of this disclosure.

FIG. 13 A sequence diagram of processing to be executed by a system including an HMD interacting in a network according to at least one embodiment of this disclosure.

FIG. 14 A schematic diagram of a mode of setting seats in a chat system according to at least one embodiment of this disclosure.

FIG. 15 A diagram of a region blocked by an avatar seated on a seat on a screen according to at least one embodiment of this disclosure.

FIG. 16 A block diagram of a configuration of modules of the computer according to at least one embodiment of this disclosure.

FIG. 17 A sequence chart of a part of processing to be executed in the HMD set according to at least one embodiment of this disclosure.

FIG. 18 A diagram of a mode of storage of chat monitor information in a memory module according to at least one embodiment of this disclosure.

FIG. 19 A diagram of a mode of storage of object information in the memory module according to at least one embodiment of this disclosure.

FIG. 20 A flowchart of processing to be executed by a processor of a computer according to at least one embodiment of this disclosure.

FIG. 21 A diagram of an example of a field-of-view image representing a chat room according to at least one embodiment of this disclosure.

FIG. 22 A flowchart of a subroutine of the control of displaying a field-of-view image according to at least one embodiment of this disclosure.

FIG. 23 A diagram of a display mode of recommended seats according to at least one embodiment of this disclosure.

FIG. 24 A diagram of a display of advice according to at least one embodiment of this disclosure.

FIG. 25 A diagram of a display of confirmation information according to at least one embodiment of this disclosure.

FIG. 26 A diagram of updated object information according to at least one embodiment of this disclosure.

FIG. 27 A diagram of an updated field-of-view image according to at least one embodiment of this disclosure.

FIG. 28 A diagram of addition of a seat to the chat room according to at least one embodiment of this disclosure.

FIG. 29 A diagram of addition of a seat to the chat room according to at least one embodiment of this disclosure.

FIG. 30 A diagram of addition of a seat to the chat room according to at least one embodiment of this disclosure.

FIG. 31 A diagram of addition of a seat to the chat room according to at least one embodiment of this disclosure.

FIG. 32 A diagram of addition of a seat to the chat room according to at least one embodiment of this disclosure.

FIG. 33 A flowchart of processing for designating a seat for an avatar to be newly arranged by the computer according to at least one embodiment of this disclosure.

FIG. 34 A diagram of a storage mode of information defining a preset recommended place according to at least one embodiment of this disclosure.

### DETAILED DESCRIPTION

Now, with reference to the drawings, embodiments of this technical idea are described in detail. In the following description, like components are denoted by like reference symbols. The same applies to the names and functions of those components. Therefore, detailed description of those components is not repeated. In one or more embodiments described in this disclosure, components of respective embodiments can be combined with each other, and the combination also serves as a part of the embodiments described in this disclosure.

[Configuration of HMD System]

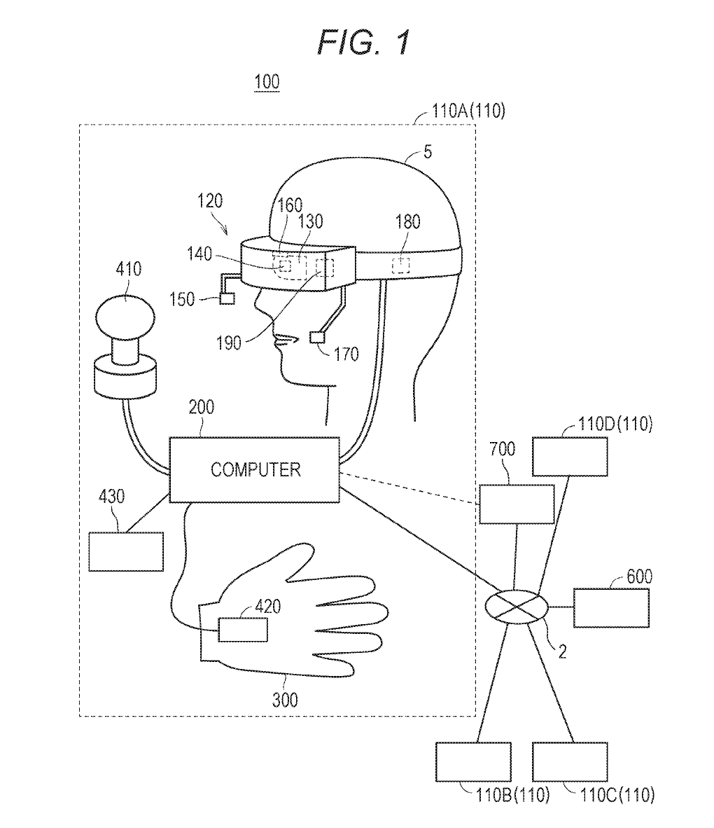

With reference to FIG. 1, a configuration of a head-mounted device (HMD) system 100 is described. FIG. 1 is a diagram of a system 100 including a head-mounted display (HMD) according to at least one embodiment of this disclosure. The system 100 is usable for household use or for professional use.

The system 100 includes a server 600, HMD sets 110A, 110B, 110C, and 110D, an external device 700, and a network 2. Each of the HMD sets 110A, 110B, 110C, and 110D is capable of independently communicating to/from the server 600 or the external device 700 via the network 2. In some instances, the HMD sets 110A, 110B, 110C, and 110D are also collectively referred to as “HMD set 110”. The number of HMD sets 110 constructing the HMD system 100 is not limited to four, but may be three or less, or five or more. The HMD set 110 includes an HMD 120, a computer 200, an HMD sensor 410, a display 430, and a controller 300. The HMD 120 includes a monitor 130, an eye gaze sensor 140, a first camera 150, a second camera 160, a microphone 170, and a speaker 180. In at least one embodiment, the controller 300 includes a motion sensor 420.

In at least one aspect, the computer 200 is connected to the network 2, for example, the Internet, and is able to communicate to/from the server 600 or other computers connected to the network 2 in a wired or wireless manner. Examples of the other computers include a computer of another HMD set 110 or the external device 700. In at least one aspect, the HMD 120 includes a sensor 190 instead of the HMD sensor 410. In at least one aspect, the HMD 120 includes both sensor 190 and the HMD sensor 410.

The HMD 120 is wearable on a head of a user 5 to display a virtual space to the user 5 during operation. More specifically, in at least one embodiment, the HMD 120 displays each of a right-eye image and a left-eye image on the monitor 130. Each eye of the user 5 is able to visually recognize a corresponding image from the right-eye image and the left-eye image so that the user 5 may recognize a three-dimensional image based on the parallax of both of the user's the eyes. In at least one embodiment, the HMD 120 includes any one of a so-called head-mounted display including a monitor or a head-mounted device capable of mounting a smartphone or other terminals including a monitor.

The monitor 130 is implemented as, for example, a non-transmissive display device. In at least one aspect, the monitor 130 is arranged on a main body of the HMD 120 so as to be positioned in front of both the eyes of the user 5. Therefore, when the user 5 is able to visually recognize the three-dimensional image displayed by the monitor 130, the user 5 is immersed in the virtual space. In at least one aspect, the virtual space includes, for example, a background, objects that are operable by the user 5, or menu images that are selectable by the user 5. In at least one aspect, the monitor 130 is implemented as a liquid crystal monitor or an organic electroluminescence (EL) monitor included in a so-called smartphone or other information display terminals.

In at least one aspect, the monitor 130 is implemented as a transmissive display device. In this case, the user 5 is able to see through the HMD 120 covering the eyes of the user 5, for example, smartglasses. In at least one embodiment, the transmissive monitor 130 is configured as a temporarily non-transmissive display device through adjustment of a transmittance thereof. In at least one embodiment, the monitor 130 is configured to display a real space and a part of an image constructing the virtual space simultaneously. For example, in at least one embodiment, the monitor 130 displays an image of the real space captured by a camera mounted on the HMD 120, or may enable recognition of the real space by setting the transmittance of a part the monitor 130 sufficiently high to permit the user 5 to see through the HMD 120.

In at least one aspect, the monitor 130 includes a sub-monitor for displaying a right-eye image and a sub-monitor for displaying a left-eye image. In at least one aspect, the monitor 130 is configured to integrally display the right-eye image and the left-eye image. In this case, the monitor 130 includes a high-speed shutter. The high-speed shutter operates so as to alternately display the right-eye image to the right of the user 5 and the left-eye image to the left eye of the user 5, so that only one of the user's 5 eyes is able to recognize the image at any single point in time.

In at least one aspect, the HMD 120 includes a plurality of light sources (not shown). Each light source is implemented by, for example, a light emitting diode (LED) configured to emit an infrared ray. The HMD sensor 410 has a position tracking function for detecting the motion of the HMD 120. More specifically, the HMD sensor 410 reads a plurality of infrared rays emitted by the HMD 120 to detect the position and the inclination of the HMD 120 in the real space.

In at least one aspect, the HMD sensor 410 is implemented by a camera. In at least one aspect, the HMD sensor 410 uses image information of the HMD 120 output from the camera to execute image analysis processing, to thereby enable detection of the position and the inclination of the HMD 120.

In at least one aspect, the HMD 120 includes the sensor 190 instead of, or in addition to, the HMD sensor 410 as a position detector. In at least one aspect, the HMD 120 uses the sensor 190 to detect the position and the inclination of the HMD 120. For example, in at least one embodiment, when the sensor 190 is an angular velocity sensor, a geomagnetic sensor, or an acceleration sensor, the HMD 120 uses any or all of those sensors instead of (or in addition to) the HMD sensor 410 to detect the position and the inclination of the HMD 120. As an example, when the sensor 190 is an angular velocity sensor, the angular velocity sensor detects over time the angular velocity about each of three axes of the HMD 120 in the real space. The HMD 120 calculates a temporal change of the angle about each of the three axes of the HMD 120 based on each angular velocity, and further calculates an inclination of the HMD 120 based on the temporal change of the angles.

The eye gaze sensor 140 detects a direction in which the lines of sight of the right eye and the left eye of the user 5 are directed. That is, the eye gaze sensor 140 detects the line of sight of the user 5. The direction of the line of sight is detected by, for example, a known eye tracking function. The eye gaze sensor 140 is implemented by a sensor having the eye tracking function. In at least one aspect, the eye gaze sensor 140 includes a right-eye sensor and a left-eye sensor. In at least one embodiment, the eye gaze sensor 140 is, for example, a sensor configured to irradiate the right eye and the left eye of the user 5 with an infrared ray, and to receive reflection light from the cornea and the iris with respect to the irradiation light, to thereby detect a rotational angle of each of the user's 5 eyeballs. In at least one embodiment, the eye gaze sensor 140 detects the line of sight of the user 5 based on each detected rotational angle.

The first camera 150 photographs a lower part of a face of the user 5. More specifically, the first camera 150 photographs, for example, the nose or mouth of the user 5. The second camera 160 photographs, for example, the eyes and eyebrows of the user 5. A side of a casing of the HMD 120 on the user 5 side is defined as an interior side of the HMD 120, and a side of the casing of the HMD 120 on a side opposite to the user 5 side is defined as an exterior side of the HMD 120. In at least one aspect, the first camera 150 is arranged on an exterior side of the HMD 120, and the second camera 160 is arranged on an interior side of the HMD 120. Images generated by the first camera 150 and the second camera 160 are input to the computer 200. In at least one aspect, the first camera 150 and the second camera 160 are implemented as a single camera, and the face of the user 5 is photographed with this single camera.

The microphone 170 converts an utterance of the user 5 into a voice signal (electric signal) for output to the computer 200. The speaker 180 converts the voice signal into a voice for output to the user 5. In at least one embodiment, the speaker 180 converts other signals into audio information provided to the user 5. In at least one aspect, the HMD 120 includes earphones in place of the speaker 180.

The controller 300 is connected to the computer 200 through wired or wireless communication. The controller 300 receives input of a command from the user 5 to the computer 200. In at least one aspect, the controller 300 is held by the user 5. In at least one aspect, the controller 300 is mountable to the body or a part of the clothes of the user 5. In at least one aspect, the controller 300 is configured to output at least anyone of a vibration, a sound, or light based on the signal transmitted from the computer 200. In at least one aspect, the controller 300 receives from the user 5 an operation for controlling the position and the motion of an object arranged in the virtual space.

In at least one aspect, the controller 300 includes a plurality of light sources. Each light source is implemented by, for example, an LED configured to emit an infrared ray. The HMD sensor 410 has a position tracking function. In this case, the HMD sensor 410 reads a plurality of infrared rays emitted by the controller 300 to detect the position and the inclination of the controller 300 in the real space. In at least one aspect, the HMD sensor 410 is implemented by a camera. In this case, the HMD sensor 410 uses image information of the controller 300 output from the camera to execute image analysis processing, to thereby enable detection of the position and the inclination of the controller 300.

In at least one aspect, the motion sensor 420 is mountable on the hand of the user 5 to detect the motion of the hand of the user 5. For example, the motion sensor 420 detects a rotational speed, a rotation angle, and the number of rotations of the hand. The detected signal is transmitted to the computer 200. The motion sensor 420 is provided to, for example, the controller 300. In at least one aspect, the motion sensor 420 is provided to, for example, the controller 300 capable of being held by the user 5. In at least one aspect, to help prevent accidently release of the controller 300 in the real space, the controller 300 is mountable on an object like a glove-type object that does not easily fly away by being worn on a hand of the user 5. In at least one aspect, a sensor that is not mountable on the user 5 detects the motion of the hand of the user 5. For example, a signal of a camera that photographs the user 5 may be input to the computer 200 as a signal representing the motion of the user 5. As at least one example, the motion sensor 420 and the computer 200 are connected to each other through wired or wireless communication. In the case of wireless communication, the communication mode is not particularly limited, and for example, Bluetooth (trademark) or other known communication methods are usable.

The display 430 displays an image similar to an image displayed on the monitor 130. With this, a user other than the user 5 wearing the HMD 120 can also view an image similar to that of the user 5. An image to be displayed on the display 430 is not required to be a three-dimensional image, but may be a right-eye image or a left-eye image. For example, a liquid crystal display or an organic EL monitor may be used as the display 430.

In at least one embodiment, the server 600 transmits a program to the computer 200. In at least one aspect, the server 600 communicates to/from another computer 200 for providing virtual reality to the HMD 120 used by another user. For example, when a plurality of users play a participatory game, for example, in an amusement facility, each computer 200 communicates to/from another computer 200 via the server 600 with a signal that is based on the motion of each user, to thereby enable the plurality of users to enjoy a common game in the same virtual space. Each computer 200 may communicate to/from another computer 200 with the signal that is based on the motion of each user without intervention of the server 600.

The external device 700 is any suitable device as long as the external device 700 is capable of communicating to/from the computer 200. The external device 700 is, for example, a device capable of communicating to/from the computer 200 via the network 2, or is a device capable of directly communicating to/from the computer 200 by near field communication or wired communication. Peripheral devices such as a smart device, a personal computer (PC), or the computer 200 are usable as the external device 700, in at least one embodiment, but the external device 700 is not limited thereto.

[Hardware Configuration of Computer]

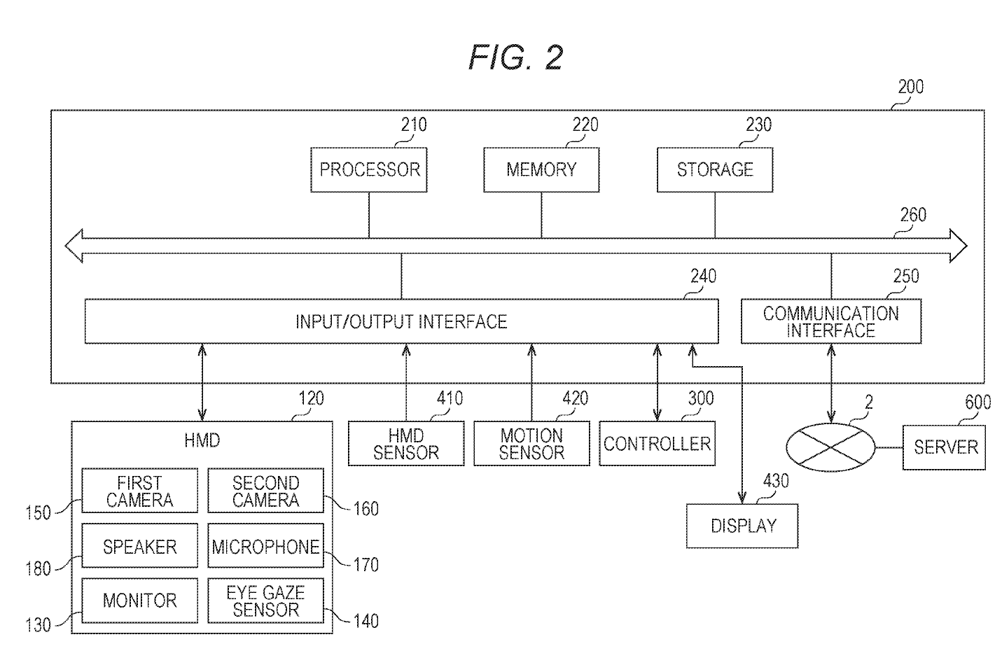

With reference to FIG. 2, the computer 200 in at least one embodiment is described. FIG. 2 is a block diagram of a hardware configuration of the computer 200 according to at least one embodiment. The computer 200 includes, a processor 210, a memory 220, a storage 230, an input/output interface 240, and a communication interface 250. Each component is connected to a bus 260. In at least one embodiment, at least one of the processor 210, the memory 220, the storage 230, the input/output interface 240 or the communication interface 250 is part of a separate structure and communicates with other components of computer 200 through a communication path other than the bus 260.

The processor 210 executes a series of commands included in a program stored in the memory 220 or the storage 230 based on a signal transmitted to the computer 200 or in response to a condition determined in advance. In at least one aspect, the processor 210 is implemented as a central processing unit (CPU), a graphics processing unit (GPU), a micro-processor unit (MPU), a field-programmable gate array (FPGA), or other devices.

The memory 220 temporarily stores programs and data. The programs are loaded from, for example, the storage 230. The data includes data input to the computer 200 and data generated by the processor 210. In at least one aspect, the memory 220 is implemented as a random access memory (RAM) or other volatile memories.

The storage 230 permanently stores programs and data. In at least one embodiment, the storage 230 stores programs and data for a period of time longer than the memory 220, but not permanently. The storage 230 is implemented as, for example, a read-only memory (ROM), a hard disk device, a flash memory, or other non-volatile storage devices. The programs stored in the storage 230 include programs for providing a virtual space in the system 100, simulation programs, game programs, user authentication programs, and programs for implementing communication to/from other computers 200. The data stored in the storage 230 includes data and objects for defining the virtual space.

In at least one aspect, the storage 230 is implemented as a removable storage device like a memory card. In at least one aspect, a configuration that uses programs and data stored in an external storage device is used instead of the storage 230 built into the computer 200. With such a configuration, for example, in a situation in which a plurality of HMD systems 100 are used, for example in an amusement facility, the programs and the data are collectively updated.

The input/output interface 240 allows communication of signals among the HMD 120, the HMD sensor 410, the motion sensor 420, and the display 430. The monitor 130, the eye gaze sensor 140, the first camera 150, the second camera 160, the microphone 170, and the speaker 180 included in the HMD 120 may communicate to/from the computer 200 via the input/output interface 240 of the HMD 120. In at least one aspect, the input/output interface 240 is implemented with use of a universal serial bus (USB), a digital visual interface (DVI), a high-definition multimedia interface (HDMI) (trademark), or other terminals. The input/output interface 240 is not limited to the specific examples described above.

In at least one aspect, the input/output interface 240 further communicates to/from the controller 300. For example, the input/output interface 240 receives input of a signal output from the controller 300 and the motion sensor 420. In at least one aspect, the input/output interface 240 transmits a command output from the processor 210 to the controller 300. The command instructs the controller 300 to, for example, vibrate, output a sound, or emit light. When the controller 300 receives the command, the controller 300 executes any one of vibration, sound output, and light emission in accordance with the command.

The communication interface 250 is connected to the network 2 to communicate to/from other computers (e.g., server 600) connected to the network 2. In at least one aspect, the communication interface 250 is implemented as, for example, a local area network (LAN), other wired communication interfaces, wireless fidelity (Wi-Fi), Bluetooth (R), near field communication (NFC), or other wireless communication interfaces. The communication interface 250 is not limited to the specific examples described above.

In at least one aspect, the processor 210 accesses the storage 230 and loads one or more programs stored in the storage 230 to the memory 220 to execute a series of commands included in the program. In at least one embodiment, the one or more programs includes an operating system of the computer 200, an application program for providing a virtual space, and/or game software that is executable in the virtual space. The processor 210 transmits a signal for providing a virtual space to the HMD 120 via the input/output interface 240. The HMD 120 displays a video on the monitor 130 based on the signal.

In FIG. 2, the computer 200 is outside of the HMD 120, but in at least one aspect, the computer 200 is integral with the HMD 120. As an example, a portable information communication terminal (e.g., smartphone) including the monitor 130 functions as the computer 200 in at least one embodiment.

In at least one embodiment, the computer 200 is used in common with a plurality of HMDs 120. With such a configuration, for example, the computer 200 is able to provide the same virtual space to a plurality of users, and hence each user can enjoy the same application with other users in the same virtual space.

According to at least one embodiment of this disclosure, in the system 100, a real coordinate system is set in advance. The real coordinate system is a coordinate system in the real space. The real coordinate system has three reference directions (axes) that are respectively parallel to a vertical direction, a horizontal direction orthogonal to the vertical direction, and a front-rear direction orthogonal to both of the vertical direction and the horizontal direction in the real space. The horizontal direction, the vertical direction (up-down direction), and the front-rear direction in the real coordinate system are defined as an x axis, a y axis, and a z axis, respectively. More specifically, the x axis of the real coordinate system is parallel to the horizontal direction of the real space, the y axis thereof is parallel to the vertical direction of the real space, and the z axis thereof is parallel to the front-rear direction of the real space.

In at least one aspect, the HMD sensor 410 includes an infrared sensor. When the infrared sensor detects the infrared ray emitted from each light source of the HMD 120, the infrared sensor detects the presence of the HMD 120. The HMD sensor 410 further detects the position and the inclination (direction) of the HMD 120 in the real space, which corresponds to the motion of the user 5 wearing the HMD 120, based on the value of each point (each coordinate value in the real coordinate system). In more detail, the HMD sensor 410 is able to detect the temporal change of the position and the inclination of the HMD 120 with use of each value detected over time.

Each inclination of the HMD 120 detected by the HMD sensor 410 corresponds to an inclination about each of the three axes of the HMD 120 in the real coordinate system. The HMD sensor 410 sets a uvw visual-field coordinate system to the HMD 120 based on the inclination of the HMD 120 in the real coordinate system. The uvw visual-field coordinate system set to the HMD 120 corresponds to a point-of-view coordinate system used when the user 5 wearing the HMD 120 views an object in the virtual space.

[Uvw Visual-Field Coordinate System]

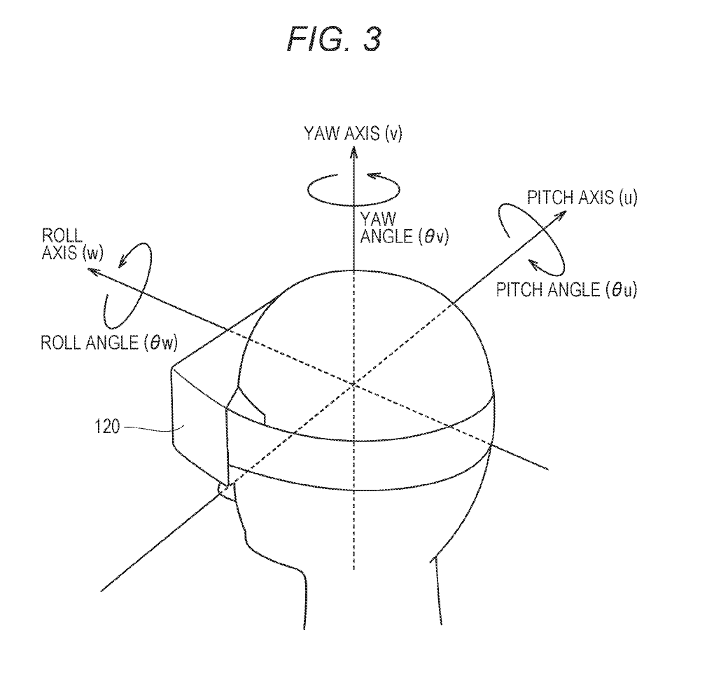

With reference to FIG. 3, the uvw visual-field coordinate system is described. FIG. 3 is a diagram of a uvw visual-field coordinate system to be set for the HMD 120 according to at least one embodiment of this disclosure. The HMD sensor 410 detects the position and the inclination of the HMD 120 in the real coordinate system when the HMD 120 is activated. The processor 210 sets the uvw visual-field coordinate system to the HMD 120 based on the detected values.

In FIG. 3, the HMD 120 sets the three-dimensional uvw visual-field coordinate system defining the head of the user 5 wearing the HMD 120 as a center (origin). More specifically, the HMD 120 sets three directions newly obtained by inclining the horizontal direction, the vertical direction, and the front-rear direction (x axis, y axis, and z axis), which define the real coordinate system, about the respective axes by the inclinations about the respective axes of the HMD 120 in the real coordinate system, as a pitch axis (u axis), a yaw axis (v axis), and a roll axis (w axis) of the uvw visual-field coordinate system in the HMD 120.

In at least one aspect, when the user 5 wearing the HMD 120 is standing (or sitting) upright and is visually recognizing the front side, the processor 210 sets the uvw visual-field coordinate system that is parallel to the real coordinate system to the HMD 120. In this case, the horizontal direction (x axis), the vertical direction (y axis), and the front-rear direction (z axis) of the real coordinate system directly match the pitch axis (u axis), the yaw axis (v axis), and the roll axis (w axis) of the uvw visual-field coordinate system in the HMD 120, respectively.

After the uvw visual-field coordinate system is set to the HMD 120, the HMD sensor 410 is able to detect the inclination of the HMD 120 in the set uvw visual-field coordinate system based on the motion of the HMD 120. In this case, the HMD sensor 410 detects, as the inclination of the HMD 120, each of a pitch angle (θu), a yaw angle (θv), and a roll angle (θw) of the HMD 120 in the uvw visual-field coordinate system. The pitch angle (θu) represents an inclination angle of the HMD 120 about the pitch axis in the uvw visual-field coordinate system. The yaw angle (θv) represents an inclination angle of the HMD 120 about the yaw axis in the uvw visual-field coordinate system. The roll angle (θw) represents an inclination angle of the HMD 120 about the roll axis in the uvw visual-field coordinate system.

The HMD sensor 410 sets, to the HMD 120, the uvw visual-field coordinate system of the HMD 120 obtained after the movement of the HMD 120 based on the detected inclination angle of the HMD 120. The relationship between the HMD 120 and the uvw visual-field coordinate system of the HMD 120 is constant regardless of the position and the inclination of the HMD 120. When the position and the inclination of the HMD 120 change, the position and the inclination of the uvw visual-field coordinate system of the HMD 120 in the real coordinate system change in synchronization with the change of the position and the inclination.

In at least one aspect, the HMD sensor 410 identifies the position of the HMD 120 in the real space as a position relative to the HMD sensor 410 based on the light intensity of the infrared ray or a relative positional relationship between a plurality of points (e.g., distance between points), which is acquired based on output from the infrared sensor. In at least one aspect, the processor 210 determines the origin of the uvw visual-field coordinate system of the HMD 120 in the real space (real coordinate system) based on the identified relative position.

[Virtual Space]

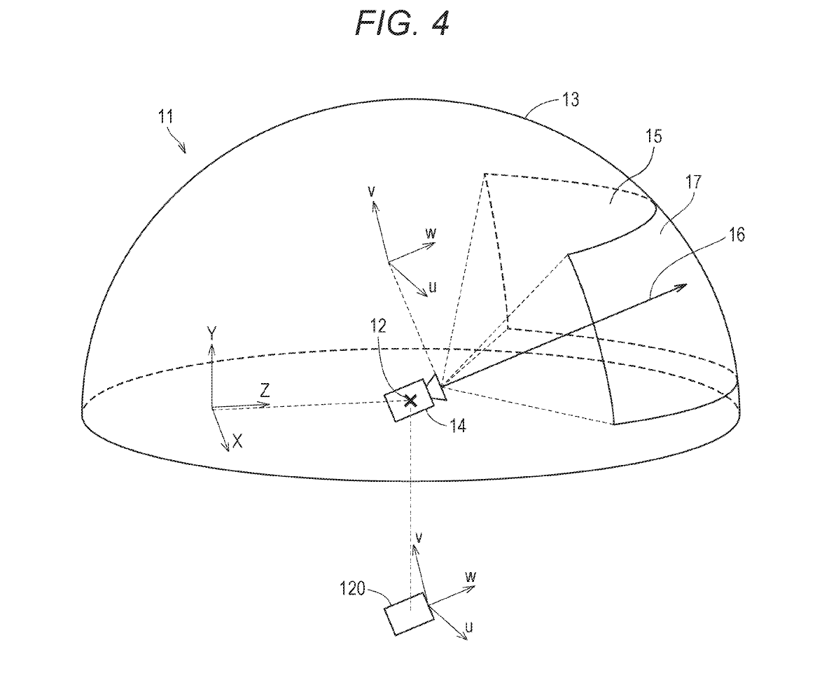

With reference to FIG. 4, the virtual space is further described. FIG. 4 is a diagram of a mode of expressing a virtual space 11 according to at least one embodiment of this disclosure. The virtual space 11 has a structure with an entire celestial sphere shape covering a center 12 in all 360-degree directions. In FIG. 4, for the sake of clarity, only the upper-half celestial sphere of the virtual space 11 is included. Each mesh section is defined in the virtual space 11. The position of each mesh section is defined in advance as coordinate values in an XYZ coordinate system, which is a global coordinate system defined in the virtual space 11. The computer 200 associates each partial image forming a panorama image 13 (e.g., still image or moving image) that is developed in the virtual space 11 with each corresponding mesh section in the virtual space 11.

In at least one aspect, in the virtual space 11, the XYZ coordinate system having the center 12 as the origin is defined. The XYZ coordinate system is, for example, parallel to the real coordinate system. The horizontal direction, the vertical direction (up-down direction), and the front-rear direction of the XYZ coordinate system are defined as an X axis, a Y axis, and a Z axis, respectively. Thus, the X axis (horizontal direction) of the XYZ coordinate system is parallel to the x axis of the real coordinate system, the Y axis (vertical direction) of the XYZ coordinate system is parallel to the y axis of the real coordinate system, and the Z axis (front-rear direction) of the XYZ coordinate system is parallel to the z axis of the real coordinate system.

When the HMD 120 is activated, that is, when the HMD 120 is in an initial state, a virtual camera 14 is arranged at the center 12 of the virtual space 11. In at least one embodiment, the virtual camera 14 is offset from the center 12 in the initial state. In at least one aspect, the processor 210 displays on the monitor 130 of the HMD 120 an image photographed by the virtual camera 14. In synchronization with the motion of the HMD 120 in the real space, the virtual camera 14 similarly moves in the virtual space 11. With this, the change in position and direction of the HMD 120 in the real space is reproduced similarly in the virtual space 11.

The uvw visual-field coordinate system is defined in the virtual camera 14 similarly to the case of the HMD 120. The uvw visual-field coordinate system of the virtual camera 14 in the virtual space 11 is defined to be synchronized with the uvw visual-field coordinate system of the HMD 120 in the real space (real coordinate system). Therefore, when the inclination of the HMD 120 changes, the inclination of the virtual camera 14 also changes in synchronization therewith. The virtual camera 14 can also move in the virtual space 11 in synchronization with the movement of the user 5 wearing the HMD 120 in the real space.

The processor 210 of the computer 200 defines a field-of-view region 15 in the virtual space 11 based on the position and inclination (reference line of sight 16) of the virtual camera 14. The field-of-view region 15 corresponds to, of the virtual space 11, the region that is visually recognized by the user 5 wearing the HMD 120. That is, the position of the virtual camera 14 determines a point of view of the user 5 in the virtual space 11.

The line of sight of the user 5 detected by the eye gaze sensor 140 is a direction in the point-of-view coordinate system obtained when the user 5 visually recognizes an object. The uvw visual-field coordinate system of the HMD 120 is equal to the point-of-view coordinate system used when the user 5 visually recognizes the monitor 130. The uvw visual-field coordinate system of the virtual camera 14 is synchronized with the uvw visual-field coordinate system of the HMD 120. Therefore, in the system 100 in at least one aspect, the line of sight of the user 5 detected by the eye gaze sensor 140 can be regarded as the line of sight of the user 5 in the uvw visual-field coordinate system of the virtual camera 14.

[User's Line of Sight]

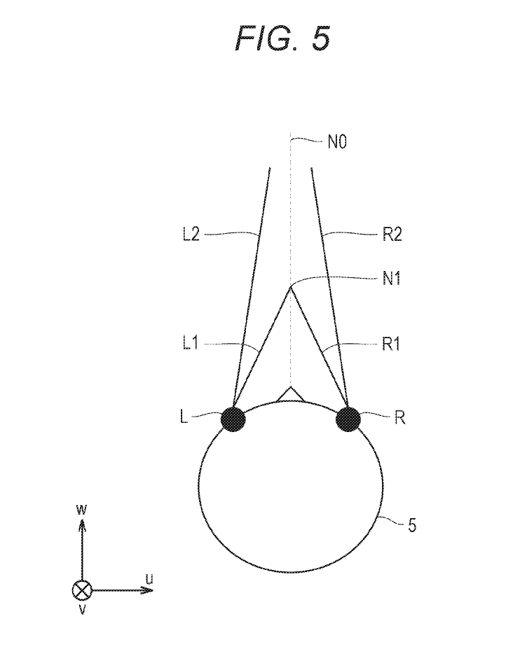

With reference to FIG. 5, determination of the line of sight of the user 5 is described. FIG. 5 is a plan view diagram of the head of the user 5 wearing the HMD 120 according to at least one embodiment of this disclosure.

In at least one aspect, the eye gaze sensor 140 detects lines of sight of the right eye and the left eye of the user 5. In at least one aspect, when the user 5 is looking at a near place, the eye gaze sensor 140 detects lines of sight R1 and L1. In at least one aspect, when the user 5 is looking at a far place, the eye gaze sensor 140 detects lines of sight R2 and L2. In this case, the angles formed by the lines of sight R2 and L2 with respect to the roll axis w are smaller than the angles formed by the lines of sight R1 and L1 with respect to the roll axis w. The eye gaze sensor 140 transmits the detection results to the computer 200.

When the computer 200 receives the detection values of the lines of sight R1 and L1 from the eye gaze sensor 140 as the detection results of the lines of sight, the computer 200 identifies a point of gaze N1 being an intersection of both the lines of sight R1 and L1 based on the detection values. Meanwhile, when the computer 200 receives the detection values of the lines of sight R2 and L2 from the eye gaze sensor 140, the computer 200 identifies an intersection of both the lines of sight R2 and L2 as the point of gaze. The computer 200 identifies a line of sight NO of the user 5 based on the identified point of gaze N1. The computer 200 detects, for example, an extension direction of a straight line that passes through the point of gaze N1 and a midpoint of a straight line connecting a right eye R and a left eye L of the user 5 to each other as the line of sight NO. The line of sight NO is a direction in which the user 5 actually directs his or her lines of sight with both eyes. The line of sight NO corresponds to a direction in which the user 5 actually directs his or her lines of sight with respect to the field-of-view region 15.

In at least one aspect, the system 100 includes a television broadcast reception tuner. With such a configuration, the system 100 is able to display a television program in the virtual space 11.

In at least one aspect, the HMD system 100 includes a communication circuit for connecting to the Internet or has a verbal communication function for connecting to a telephone line or a cellular service.

[Field-of-View Region]

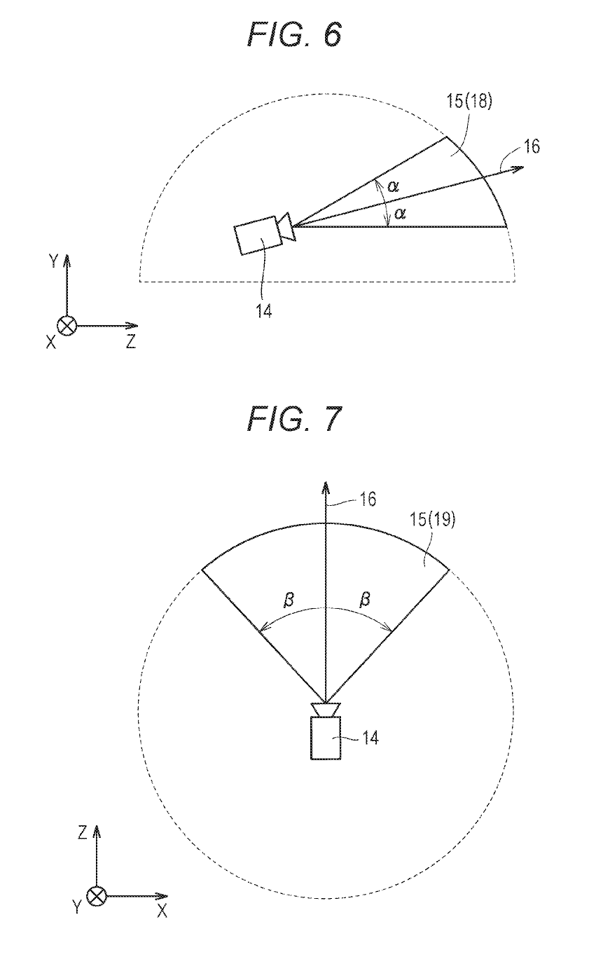

With reference to FIG. 6 and FIG. 7, the field-of-view region 15 is described. FIG. 6 is a diagram of a YZ cross section obtained by viewing the field-of-view region 15 from an X direction in the virtual space 11. FIG. 7 is a diagram of an XZ cross section obtained by viewing the field-of-view region 15 from a Y direction in the virtual space 11.

In FIG. 6, the field-of-view region 15 in the YZ cross section includes a region 18. The region 18 is defined by the position of the virtual camera 14, the reference line of sight 16, and the YZ cross section of the virtual space 11. The processor 210 defines a range of a polar angle α from the reference line of sight 16 serving as the center in the virtual space as the region 18.

In FIG. 7, the field-of-view region 15 in the XZ cross section includes a region 19. The region 19 is defined by the position of the virtual camera 14, the reference line of sight 16, and the XZ cross section of the virtual space 11. The processor 210 defines a range of an azimuth p from the reference line of sight 16 serving as the center in the virtual space 11 as the region 19. The polar angle α and β are determined in accordance with the position of the virtual camera 14 and the inclination (direction) of the virtual camera 14.

In at least one aspect, the system 100 causes the monitor 130 to display a field-of-view image 17 based on the signal from the computer 200, to thereby provide the field of view in the virtual space 11 to the user 5. The field-of-view image 17 corresponds to a part of the panorama image 13, which corresponds to the field-of-view region 15. When the user 5 moves the HMD 120 worn on his or her head, the virtual camera 14 is also moved in synchronization with the movement. As a result, the position of the field-of-view region 15 in the virtual space 11 is changed. With this, the field-of-view image 17 displayed on the monitor 130 is updated to an image of the panorama image 13, which is superimposed on the field-of-view region 15 synchronized with a direction in which the user 5 faces in the virtual space 11. The user 5 can visually recognize a desired direction in the virtual space 11.

In this way, the inclination of the virtual camera 14 corresponds to the line of sight of the user 5 (reference line of sight 16) in the virtual space 11, and the position at which the virtual camera 14 is arranged corresponds to the point of view of the user 5 in the virtual space 11. Therefore, through the change of the position or inclination of the virtual camera 14, the image to be displayed on the monitor 130 is updated, and the field of view of the user 5 is moved.

While the user 5 is wearing the HMD 120 (having a non-transmissive monitor 130), the user 5 can visually recognize only the panorama image 13 developed in the virtual space 11 without visually recognizing the real world. Therefore, the system 100 provides a high sense of immersion in the virtual space 11 to the user 5.

In at least one aspect, the processor 210 moves the virtual camera 14 in the virtual space 11 in synchronization with the movement in the real space of the user 5 wearing the HMD 120. In this case, the processor 210 identifies an image region to be projected on the monitor 130 of the HMD 120 (field-of-view region 15) based on the position and the direction of the virtual camera 14 in the virtual space 11.

In at least one aspect, the virtual camera 14 includes two virtual cameras, that is, a virtual camera for providing a right-eye image and a virtual camera for providing a left-eye image. An appropriate parallax is set for the two virtual cameras so that the user 5 is able to recognize the three-dimensional virtual space 11. In at least one aspect, the virtual camera 14 is implemented by a single virtual camera. In this case, a right-eye image and a left-eye image may be generated from an image acquired by the single virtual camera. In at least one embodiment, the virtual camera 14 is assumed to include two virtual cameras, and the roll axes of the two virtual cameras are synthesized so that the generated roll axis (w) is adapted to the roll axis (w) of the HMD 120.

[Controller]

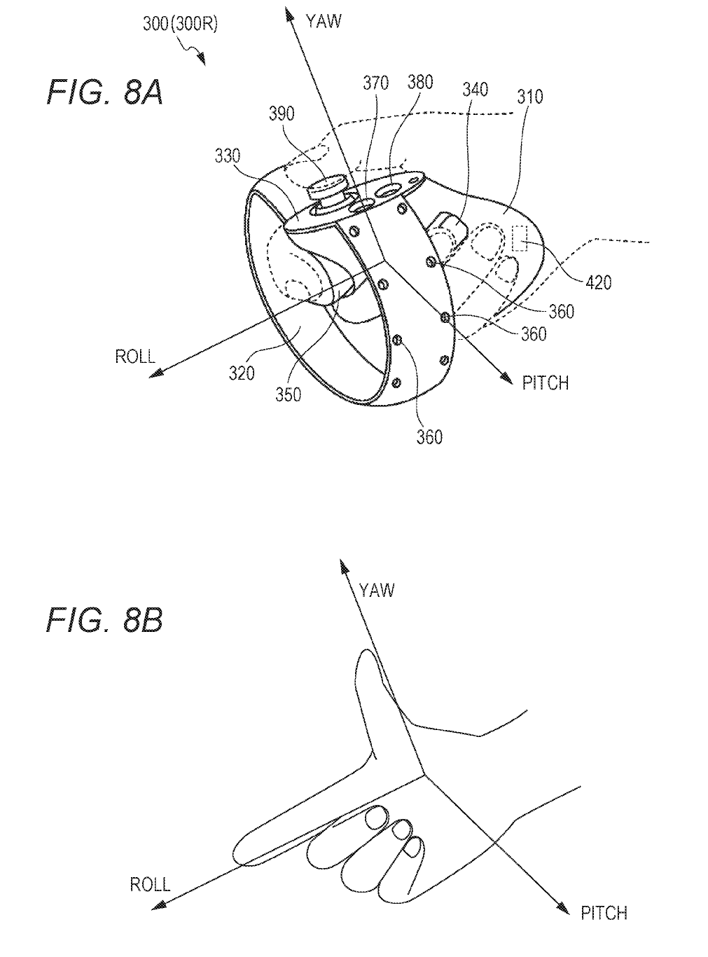

An example of the controller 300 is described with reference to FIG. 8A and FIG. 8B. FIG. 8A is a diagram of a schematic configuration of a controller according to at least one embodiment of this disclosure. FIG. 8B is a diagram of a coordinate system to be set for a hand of a user holding the controller according to at least one embodiment of this disclosure.

In at least one aspect, the controller 300 includes a right controller 300R and a left controller (not shown). In FIG. 8A only right controller 300R is shown for the sake of clarity. The right controller 300R is operable by the right hand of the user 5. The left controller is operable by the left hand of the user 5. In at least one aspect, the right controller 300R and the left controller are symmetrically configured as separate devices. Therefore, the user 5 can freely move his or her right hand holding the right controller 300R and his or her left hand holding the left controller. In at least one aspect, the controller 300 may be an integrated controller configured to receive an operation performed by both the right and left hands of the user 5. The right controller 300R is now described.

The right controller 300R includes a grip 310, a frame 320, and a top surface 330. The grip 310 is configured so as to be held by the right hand of the user 5. For example, the grip 310 may be held by the palm and three fingers (e.g., middle finger, ring finger, and small finger) of the right hand of the user 5.

The grip 310 includes buttons 340 and 350 and the motion sensor 420. The button 340 is arranged on a side surface of the grip 310, and receives an operation performed by, for example, the middle finger of the right hand. The button 350 is arranged on a front surface of the grip 310, and receives an operation performed by, for example, the index finger of the right hand. In at least one aspect, the buttons 340 and 350 are configured as trigger type buttons. The motion sensor 420 is built into the casing of the grip 310. When a motion of the user 5 can be detected from the surroundings of the user 5 by a camera or other device. In at least one embodiment, the grip 310 does not include the motion sensor 420.

The frame 320 includes a plurality of infrared LEDs 360 arranged in a circumferential direction of the frame 320. The infrared LEDs 360 emit, during execution of a program using the controller 300, infrared rays in accordance with progress of the program. The infrared rays emitted from the infrared LEDs 360 are usable to independently detect the position and the posture (inclination and direction) of each of the right controller 300R and the left controller. In FIG. 8A, the infrared LEDs 360 are shown as being arranged in two rows, but the number of arrangement rows is not limited to that illustrated in FIG. 8. In at least one embodiment, the infrared LEDs 360 are arranged in one row or in three or more rows. In at least one embodiment, the infrared LEDs 360 are arranged in a pattern other than rows.

The top surface 330 includes buttons 370 and 380 and an analog stick 390. The buttons 370 and 380 are configured as push type buttons. The buttons 370 and 380 receive an operation performed by the thumb of the right hand of the user 5. In at least one aspect, the analog stick 390 receives an operation performed in any direction of 360 degrees from an initial position (neutral position). The operation includes, for example, an operation for moving an object arranged in the virtual space 11.

In at least one aspect, each of the right controller 300R and the left controller includes a battery for driving the infrared ray LEDs 360 and other members. The battery includes, for example, a rechargeable battery, a button battery, a dry battery, but the battery is not limited thereto. In at least one aspect, the right controller 300R and the left controller are connectable to, for example, a USB interface of the computer 200. In at least one embodiment, the right controller 300R and the left controller do not include a battery.

In FIG. 8A and FIG. 8B, for example, a yaw direction, a roll direction, and a pitch direction are defined with respect to the right hand of the user 5. A direction of an extended thumb is defined as the yaw direction, a direction of an extended index finger is defined as the roll direction, and a direction perpendicular to a plane is defined as the pitch direction.

[Hardware Configuration of Server]

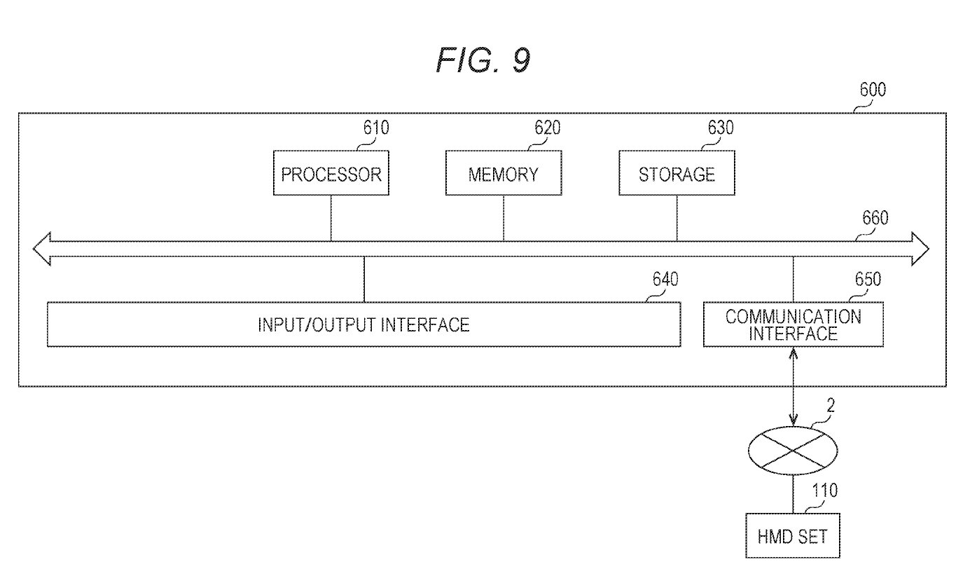

With reference to FIG. 9, the server 600 in at least one embodiment is described. FIG. 9 is a block diagram of a hardware configuration of the server 600 according to at least one embodiment of this disclosure. The server 600 includes a processor 610, a memory 620, a storage 630, an input/output interface 640, and a communication interface 650. Each component is connected to a bus 660. In at least one embodiment, at least one of the processor 610, the memory 620, the storage 630, the input/output interface 640 or the communication interface 650 is part of a separate structure and communicates with other components of server 600 through a communication path other than the bus 660.

The processor 610 executes a series of commands included in a program stored in the memory 620 or the storage 630 based on a signal transmitted to the server 600 or on satisfaction of a condition determined in advance. In at least one aspect, the processor 610 is implemented as a central processing unit (CPU), a graphics processing unit (GPU), a micro processing unit (MPU), a field-programmable gate array (FPGA), or other devices.

The memory 620 temporarily stores programs and data. The programs are loaded from, for example, the storage 630. The data includes data input to the server 600 and data generated by the processor 610. In at least one aspect, the memory 620 is implemented as a random access memory (RAM) or other volatile memories.

The storage 630 permanently stores programs and data. In at least one embodiment, the storage 630 stores programs and data for a period of time longer than the memory 620, but not permanently. The storage 630 is implemented as, for example, a read-only memory (ROM), a hard disk device, a flash memory, or other non-volatile storage devices. The programs stored in the storage 630 include programs for providing a virtual space in the system 100, simulation programs, game programs, user authentication programs, and programs for implementing communication to/from other computers 200 or servers 600. The data stored in the storage 630 may include, for example, data and objects for defining the virtual space.

In at least one aspect, the storage 630 is implemented as a removable storage device like a memory card. In at least one aspect, a configuration that uses programs and data stored in an external storage device is used instead of the storage 630 built into the server 600. With such a configuration, for example, in a situation in which a plurality of HMD systems 100 are used, for example, as in an amusement facility, the programs and the data are collectively updated.

The input/output interface 640 allows communication of signals to/from an input/output device. In at least one aspect, the input/output interface 640 is implemented with use of a USB, a DVI, an HDMI, or other terminals. The input/output interface 640 is not limited to the specific examples described above.

The communication interface 650 is connected to the network 2 to communicate to/from the computer 200 connected to the network 2. In at least one aspect, the communication interface 650 is implemented as, for example, a LAN, other wired communication interfaces, Wi-Fi, Bluetooth, NFC, or other wireless communication interfaces. The communication interface 650 is not limited to the specific examples described above.

In at least one aspect, the processor 610 accesses the storage 630 and loads one or more programs stored in the storage 630 to the memory 620 to execute a series of commands included in the program. In at least one embodiment, the one or more programs include, for example, an operating system of the server 600, an application program for providing a virtual space, and game software that can be executed in the virtual space. In at least one embodiment, the processor 610 transmits a signal for providing a virtual space to the HMD device 110 to the computer 200 via the input/output interface 640.

[Control Device of HMD]

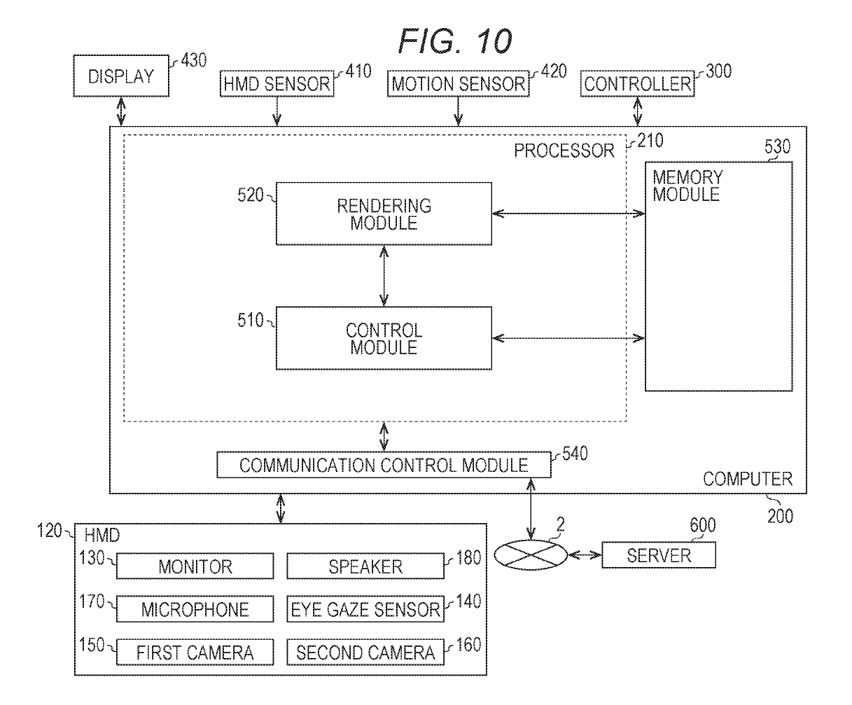

With reference to FIG. 10, the control device of the HMD 120 is described. According to at least one embodiment of this disclosure, the control device is implemented by the computer 200 having a known configuration. FIG. 10 is a block diagram of the computer 200 according to at least one embodiment of this disclosure. FIG. 10 includes a module configuration of the computer 200.

In FIG. 10, the computer 200 includes a control module 510, a rendering module 520, a memory module 530, and a communication control module 540. In at least one aspect, the control module 510 and the rendering module 520 are implemented by the processor 210. In at least one aspect, a plurality of processors 210 function as the control module 510 and the rendering module 520. The memory module 530 is implemented by the memory 220 or the storage 230. The communication control module 540 is implemented by the communication interface 250.

The control module 510 controls the virtual space 11 provided to the user 5. The control module 510 defines the virtual space 11 in the HMD system 100 using virtual space data representing the virtual space 11. The virtual space data is stored in, for example, the memory module 530. In at least one embodiment, the control module 510 generates virtual space data. In at least one embodiment, the control module 510 acquires virtual space data from, for example, the server 600.

The control module 510 arranges objects in the virtual space 11 using object data representing objects. The object data is stored in, for example, the memory module 530. In at least one embodiment, the control module 510 generates virtual space data. In at least one embodiment, the control module 510 acquires virtual space data from, for example, the server 600. In at least one embodiment, the objects include, for example, an avatar object of the user 5, character objects, operation objects, for example, a virtual hand to be operated by the controller 300, and forests, mountains, other landscapes, streetscapes, or animals to be arranged in accordance with the progression of the story of the game.

The control module 510 arranges an avatar object of the user 5 of another computer 200, which is connected via the network 2, in the virtual space 11. In at least one aspect, the control module 510 arranges an avatar object of the user 5 in the virtual space 11. In at least one aspect, the control module 510 arranges an avatar object simulating the user 5 in the virtual space 11 based on an image including the user 5. In at least one aspect, the control module 510 arranges an avatar object in the virtual space 11, which is selected by the user 5 from among a plurality of types of avatar objects (e.g., objects simulating animals or objects of deformed humans).

The control module 510 identifies an inclination of the HMD 120 based on output of the HMD sensor 410. In at least one aspect, the control module 510 identifies an inclination of the HMD 120 based on output of the sensor 190 functioning as a motion sensor. The control module 510 detects parts (e.g., mouth, eyes, and eyebrows) forming the face of the user 5 from a face image of the user 5 generated by the first camera 150 and the second camera 160. The control module 510 detects a motion (shape) of each detected part.

The control module 510 detects a line of sight of the user 5 in the virtual space 11 based on a signal from the eye gaze sensor 140. The control module 510 detects a point-of-view position (coordinate values in the XYZ coordinate system) at which the detected line of sight of the user 5 and the celestial sphere of the virtual space 11 intersect with each other. More specifically, the control module 510 detects the point-of-view position based on the line of sight of the user 5 defined in the uvw coordinate system and the position and the inclination of the virtual camera 14. The control module 510 transmits the detected point-of-view position to the server 600. In at least one aspect, the control module 510 is configured to transmit line-of-sight information representing the line of sight of the user 5 to the server 600. In such a case, the control module 510 may calculate the point-of-view position based on the line-of-sight information received by the server 600.

The control module 510 translates a motion of the HMD 120, which is detected by the HMD sensor 410, in an avatar object. For example, the control module 510 detects inclination of the HMD 120, and arranges the avatar object in an inclined manner. The control module 510 translates the detected motion of face parts in a face of the avatar object arranged in the virtual space 11. The control module 510 receives line-of-sight information of another user 5 from the server 600, and translates the line-of-sight information in the line of sight of the avatar object of another user 5. In at least one aspect, the control module 510 translates a motion of the controller 300 in an avatar object and an operation object. In this case, the controller 300 includes, for example, a motion sensor, an acceleration sensor, or a plurality of light emitting elements (e.g., infrared LEDs) for detecting a motion of the controller 300.

The control module 510 arranges, in the virtual space 11, an operation object for receiving an operation by the user 5 in the virtual space 11. The user 5 operates the operation object to, for example, operate an object arranged in the virtual space 11. In at least one aspect, the operation object includes, for example, a hand object serving as a virtual hand corresponding to a hand of the user 5. In at least one aspect, the control module 510 moves the hand object in the virtual space 11 so that the hand object moves in association with a motion of the hand of the user 5 in the real space based on output of the motion sensor 420. In at least one aspect, the operation object may correspond to a hand part of an avatar object.

When one object arranged in the virtual space 11 collides with another object, the control module 510 detects the collision. The control module 510 is able to detect, for example, a timing at which a collision area of one object and a collision area of another object have touched with each other, and performs predetermined processing in response to the detected timing. In at least one embodiment, the control module 510 detects a timing at which an object and another object, which have been in contact with each other, have moved away from each other, and performs predetermined processing in response to the detected timing. In at least one embodiment, the control module 510 detects a state in which an object and another object are in contact with each other. For example, when an operation object touches another object, the control module 510 detects the fact that the operation object has touched the other object, and performs predetermined processing.

In at least one aspect, the control module 510 controls image display of the HMD 120 on the monitor 130. For example, the control module 510 arranges the virtual camera 14 in the virtual space 11. The control module 510 controls the position of the virtual camera 14 and the inclination (direction) of the virtual camera 14 in the virtual space 11. The control module 510 defines the field-of-view region 15 depending on an inclination of the head of the user 5 wearing the HMD 120 and the position of the virtual camera 14. The rendering module 520 generates the field-of-view region 17 to be displayed on the monitor 130 based on the determined field-of-view region 15. The communication control module 540 outputs the field-of-view region 17 generated by the rendering module 520 to the HMD 120.

The control module 510, which has detected an utterance of the user 5 using the microphone 170 from the HMD 120, identifies the computer 200 to which voice data corresponding to the utterance is to be transmitted. The voice data is transmitted to the computer 200 identified by the control module 510. The control module 510, which has received voice data from the computer 200 of another user via the network 2, outputs audio information (utterances) corresponding to the voice data from the speaker 180.

The memory module 530 holds data to be used to provide the virtual space 11 to the user 5 by the computer 200. In at least one aspect, the memory module 530 stores space information, object information, and user information.

The space information stores one or more templates defined to provide the virtual space 11.

The object information stores a plurality of panorama images 13 forming the virtual space 11 and object data for arranging objects in the virtual space 11. In at least one embodiment, the panorama image 13 contains a still image and/or a moving image. In at least one embodiment, the panorama image 13 contains an image in a non-real space and/or an image in the real space. An example of the image in a non-real space is an image generated by computer graphics.

The user information stores a user ID for identifying the user 5. The user ID is, for example, an internet protocol (IP) address or a media access control (MAC) address set to the computer 200 used by the user. In at least one aspect, the user ID is set by the user. The user information stores, for example, a program for causing the computer 200 to function as the control device of the HMD system 100.

The data and programs stored in the memory module 530 are input by the user 5 of the HMD 120. Alternatively, the processor 210 downloads the programs or data from a computer (e.g., server 600) that is managed by a business operator providing the content, and stores the downloaded programs or data in the memory module 530.

In at least one embodiment, the communication control module 540 communicates to/from the server 600 or other information communication devices via the network 2.

In at least one aspect, the control module 510 and the rendering module 520 are implemented with use of, for example, Unity (R) provided by Unity Technologies. In at least one aspect, the control module 510 and the rendering module 520 are implemented by combining the circuit elements for implementing each step of processing.

The processing performed in the computer 200 is implemented by hardware and software executed by the processor 410. In at least one embodiment, the software is stored in advance on a hard disk or other memory module 530. In at least one embodiment, the software is stored on a CD-ROM or other computer-readable non-volatile data recording media, and distributed as a program product. In at least one embodiment, the software may is provided as a program product that is downloadable by an information provider connected to the Internet or other networks. Such software is read from the data recording medium by an optical disc drive device or other data reading devices, or is downloaded from the server 600 or other computers via the communication control module 540 and then temporarily stored in a storage module. The software is read from the storage module by the processor 210, and is stored in a RAM in a format of an executable program. The processor 210 executes the program.

[Control Structure of HMD System]

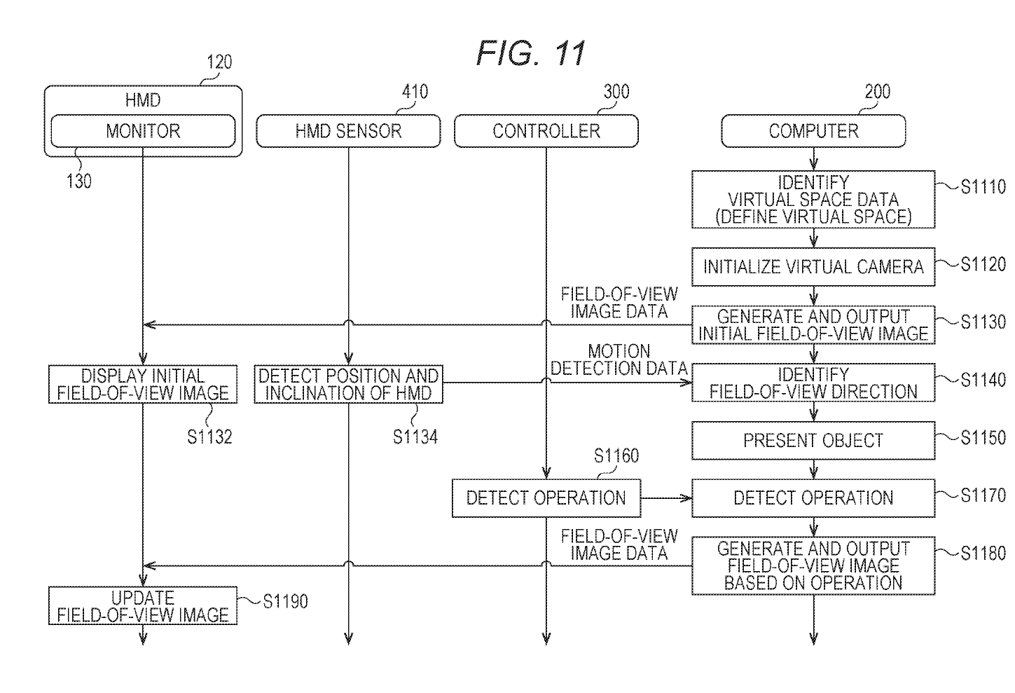

With reference to FIG. 11, the control structure of the HMD set 110 is described. FIG. 11 is a sequence chart of processing to be executed by the system 100 according to at least one embodiment of this disclosure.

In FIG. 11, in Step S1110, the processor 210 of the computer 200 serves as the control module 510 to identify virtual space data and define the virtual space 11.

In Step S1120, the processor 210 initializes the virtual camera 14. For example, in a work area of the memory, the processor 210 arranges the virtual camera 14 at the center 12 defined in advance in the virtual space 11, and matches the line of sight of the virtual camera 14 with the direction in which the user 5 faces.

In Step S1130, the processor 210 serves as the rendering module 520 to generate field-of-view image data for displaying an initial field-of-view image. The generated field-of-view image data is output to the HMD 120 by the communication control module 540.

In Step S1132, the monitor 130 of the HMD 120 displays the field-of-view image based on the field-of-view image data received from the computer 200. The user 5 wearing the HMD 120 is able to recognize the virtual space 11 through visual recognition of the field-of-view image.

In Step S1134, the HMD sensor 410 detects the position and the inclination of the HMD 120 based on a plurality of infrared rays emitted from the HMD 120. The detection results are output to the computer 200 as motion detection data.

In Step S1140, the processor 210 identifies a field-of-view direction of the user 5 wearing the HMD 120 based on the position and inclination contained in the motion detection data of the HMD 120.

In Step S1150, the processor 210 executes an application program, and arranges an object in the virtual space 11 based on a command contained in the application program.

In Step S1160, the controller 300 detects an operation by the user 5 based on a signal output from the motion sensor 420, and outputs detection data representing the detected operation to the computer 200. In at least one aspect, an operation of the controller 300 by the user 5 is detected based on an image from a camera arranged around the user 5.

In Step S1170, the processor 210 detects an operation of the controller 300 by the user 5 based on the detection data acquired from the controller 300.

In Step S1180, the processor 210 generates field-of-view image data based on the operation of the controller 300 by the user 5. The communication control module 540 outputs the generated field-of-view image data to the HMD 120.

In Step S1190, the HMD 120 updates a field-of-view image based on the received field-of-view image data, and displays the updated field-of-view image on the monitor 130.

[Avatar Object]

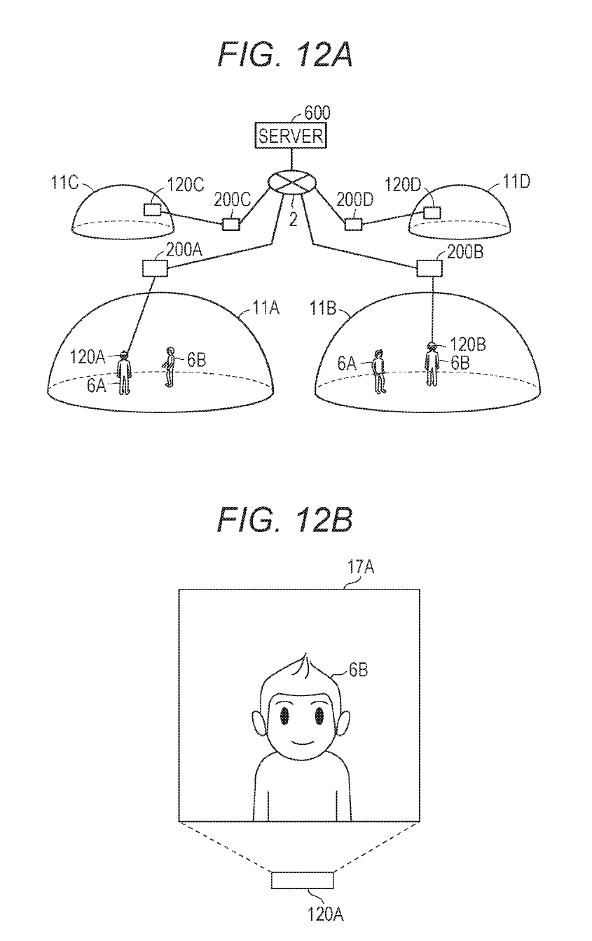

With reference to FIG. 12A and FIG. 12B, an avatar object according to at least one embodiment is described. FIG. 12 and FIG. 12B are diagrams of avatar objects of respective users 5 of the HMD sets 110A and 110B. In the following, the user of the HMD set 110A, the user of the HMD set 110B, the user of the HMD set 110C, and the user of the HMD set 110D are referred to as “user 5A”, “user 5B”, “user 5C”, and “user 5D”, respectively. A reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively. For example, the HMD 120A is included in the HMD set 110A.

FIG. 12A is a schematic diagram of HMD systems of several users sharing the virtual space interact using a network according to at least one embodiment of this disclosure. Each HMD 120 provides the user 5 with the virtual space 11. Computers 200A to 200D provide the users 5A to 5D with virtual spaces 11A to 11D via HMDs 120A to 120D, respectively. In FIG. 12A, the virtual space 11A and the virtual space 11B are formed by the same data. In other words, the computer 200A and the computer 200B share the same virtual space. An avatar object 6A of the user 5A and an avatar object 6B of the user 5B are present in the virtual space 11A and the virtual space 11B. The avatar object 6A in the virtual space 11A and the avatar object 6B in the virtual space 11B each wear the HMD 120. However, the inclusion of the HMD 120A and HMD 120B is only for the sake of simplicity of description, and the avatars do not wear the HMD 120A and HMD 120B in the virtual spaces 11A and 11B, respectively.

In at least one aspect, the processor 210A arranges a virtual camera 14A for photographing a field-of-view region 17A of the user 5A at the position of eyes of the avatar object 6A.

FIG. 12B is a diagram of a field of view of a HMD according to at least one embodiment of this disclosure. FIG. 12(B) corresponds to the field-of-view region 17A of the user 5A in FIG. 12A. The field-of-view region 17A is an image displayed on a monitor 130A of the HMD 120A. This field-of-view region 17A is an image generated by the virtual camera 14A. The avatar object 6B of the user 5B is displayed in the field-of-view region 17A. Although not included in FIG. 12B, the avatar object 6A of the user 5A is displayed in the field-of-view image of the user 5B.

In the arrangement in FIG. 12B, the user 5A can communicate to/from the user 5B via the virtual space 11A through conversation. More specifically, voices of the user 5A acquired by a microphone 170A are transmitted to the HMD 120B of the user 5B via the server 600 and output from a speaker 180B provided on the HMD 120B. Voices of the user 5B are transmitted to the HMD 120A of the user 5A via the server 600, and output from a speaker 180A provided on the HMD 120A.

The processor 210A translates an operation by the user 5B (operation of HMD 120B and operation of controller 300B) in the avatar object 6B arranged in the virtual space 11A. With this, the user 5A is able to recognize the operation by the user 5B through the avatar object 6B.

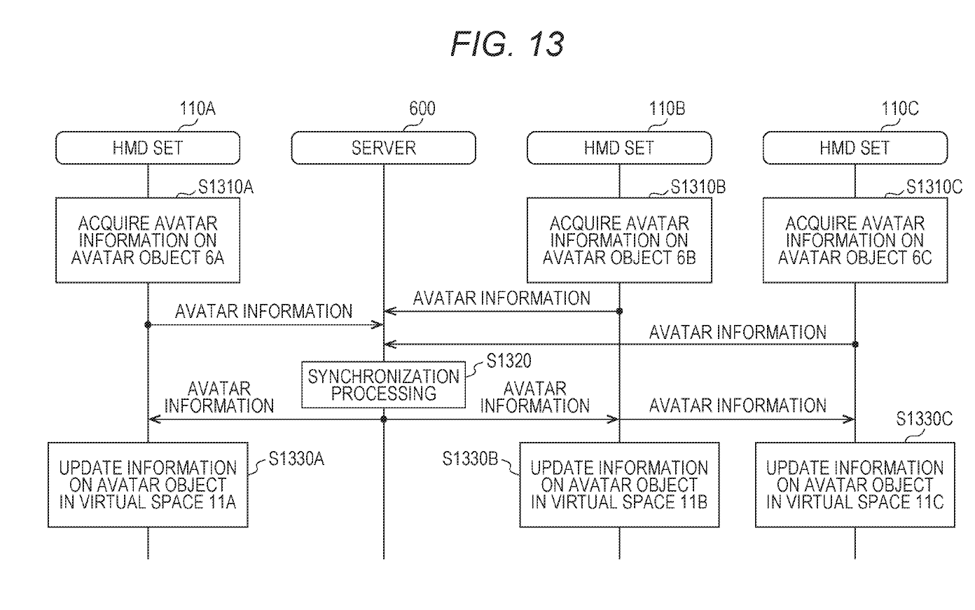

FIG. 13 is a sequence chart of processing to be executed by the system 100 according to at least one embodiment of this disclosure. In FIG. 13, although the HMD set 110D is not included, the HMD set 110D operates in a similar manner as the HMD sets 110A, 110B, and 110C. Also in the following description, a reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively.

In Step S1310A, the processor 210A of the HMD set 110A acquires avatar information for determining a motion of the avatar object 6A in the virtual space 11A. This avatar information contains information on an avatar such as motion information, face tracking data, and sound data. The motion information contains, for example, information on a temporal change in position and inclination of the HMD 120A and information on a motion of the hand of the user 5A, which is detected by, for example, a motion sensor 420A. An example of the face tracking data is data identifying the position and size of each part of the face of the user 5A. Another example of the face tracking data is data representing motions of parts forming the face of the user 5A and line-of-sight data. An example of the sound data is data representing sounds of the user 5A acquired by the microphone 170A of the HMD 120A. In at least one embodiment, the avatar information contains information identifying the avatar object 6A or the user 5A associated with the avatar object 6A or information identifying the virtual space 11A accommodating the avatar object 6A. An example of the information identifying the avatar object 6A or the user 5A is a user ID. An example of the information identifying the virtual space 11A accommodating the avatar object 6A is a room ID. The processor 210A transmits the avatar information acquired as described above to the server 600 via the network 2.

In Step S1310B, the processor 210B of the HMD set 110B acquires avatar information for determining a motion of the avatar object 6B in the virtual space 11B, and transmits the avatar information to the server 600, similarly to the processing of Step S1310A. Similarly, in Step S1310C, the processor 210C of the HMD set 110C acquires avatar information for determining a motion of the avatar object 6C in the virtual space 11C, and transmits the avatar information to the server 600.

In Step S1320, the server 600 temporarily stores pieces of player information received from the HMD set 110A, the HMD set 110B, and the HMD set 110C, respectively. The server 600 integrates pieces of avatar information of all the users (in this example, users 5A to 5C) associated with the common virtual space 11 based on, for example, the user IDs and room IDs contained in respective pieces of avatar information. Then, the server 600 transmits the integrated pieces of avatar information to all the users associated with the virtual space 11 at a timing determined in advance. In this manner, synchronization processing is executed. Such synchronization processing enables the HMD set 110A, the HMD set 110B, and the HMD 120C to share mutual avatar information at substantially the same timing.

Next, the HMD sets 110A to 110C execute processing of Step S1330A to Step S1330C, respectively, based on the integrated pieces of avatar information transmitted from the server 600 to the HMD sets 110A to 110C. The processing of Step S1330A corresponds to the processing of Step S1180 of FIG. 11.

In Step S1330A, the processor 210A of the HMD set 110A updates information on the avatar object 6B and the avatar object 6C of the other users 5B and 5C in the virtual space 11A. Specifically, the processor 210A updates, for example, the position and direction of the avatar object 6B in the virtual space 11 based on motion information contained in the avatar information transmitted from the HMD set 110B. For example, the processor 210A updates the information (e.g., position and direction) on the avatar object 6B contained in the object information stored in the memory module 530. Similarly, the processor 210A updates the information (e.g., position and direction) on the avatar object 6C in the virtual space 11 based on motion information contained in the avatar information transmitted from the HMD set 110C.

In Step S1330B, similarly to the processing of Step S1330A, the processor 210B of the HMD set 110B updates information on the avatar object 6A and the avatar object 6C of the users 5A and 5C in the virtual space 11B. Similarly, in Step S1330C, the processor 210C of the HMD set 110C updates information on the avatar object 6A and the avatar object 6B of the users 5A and 5B in the virtual space 11C.

<1. Summary of Disclosure>

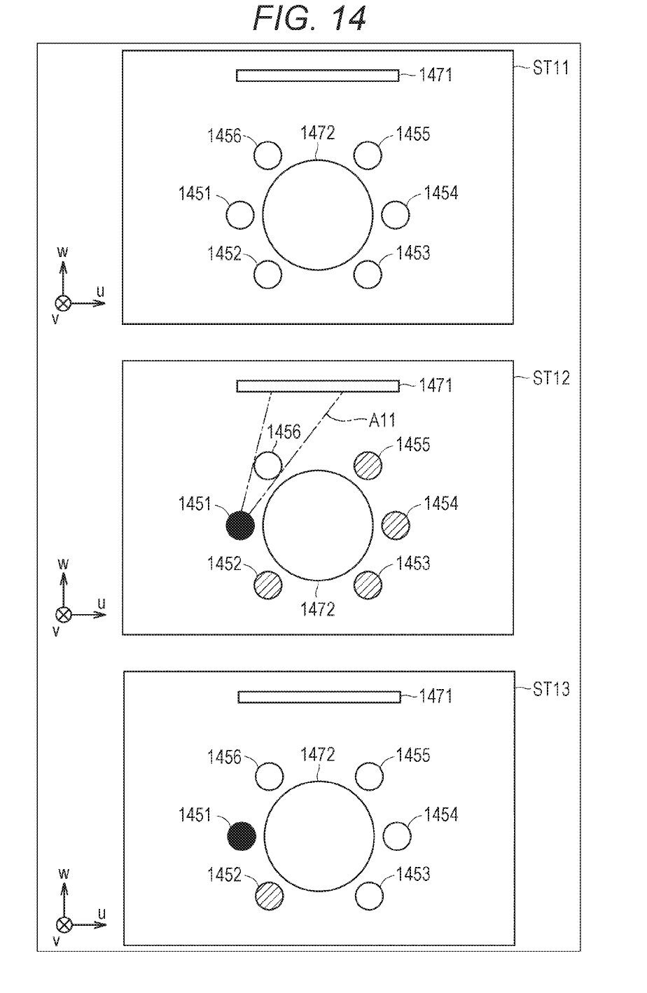

In this disclosure, a chat system is provided as an example of a virtual space. A “seat” is employed as an example of a “place” defined in the virtual space. FIG. 14 is a schematic diagram of a mode of setting seats in a chat system according to at least one aspect of this disclosure. In FIG. 14, three stages for seat setting are shown as states ST11 to ST13.

The state ST11 represents a state in which the chat room is viewed from above in a u axis-w axis plane of a uvw visual field coordinate system. The chat room includes a table 1472, six seats 1451 to 1456, and a screen 1471. The avatars of the users are scheduled to be seated on the seats 1451 to 1456. An avatar is an example of an object. The seating of an avatar in the chat room is an example of the arrangement of an object in the virtual space. In at least one embodiment, the term “avatar” is synonymous with “avatar object”.

The state ST12 represents a state in which an avatar corresponding to a certain user is seated on the seat 1451. In the state ST12, avatars are not seated on the seats 1452 to 1456. In the state ST12, the chat system selects and outputs, in accordance with a condition determined in advance, one or more of the seats 1452 to 1456 as a recommended seat for the avatar to be newly seated.

An example of the condition for selecting a recommended seat is maintaining, even after the avatar has been arranged on the selected seat, a fixed ratio or more of the field of view from an avatar that is already seated on the seat 1451 to the screen 1471.

The maintained ratio of the field of view from the avatar seated on the seat 1451 to the screen 1471 is calculated by assuming that the avatar is seated on each of the seats 1452 to 1456. In the state ST12, in at least one embodiment, the avatar is seated on the seat 1456.

A region A11 represents, of the field-of-view region of the avatar seated on the seat 1451, the region blocked by the avatar seated on the seat 1456. An example of the shape of the region A11 is a three-dimensional shape formed by a set of straight lines reaching the screen 1471 through the surface of the avatar seated on the seat 1456 from a specific position (e.g., intermediate point between both eyes) of the avatar seated on the seat 1451.

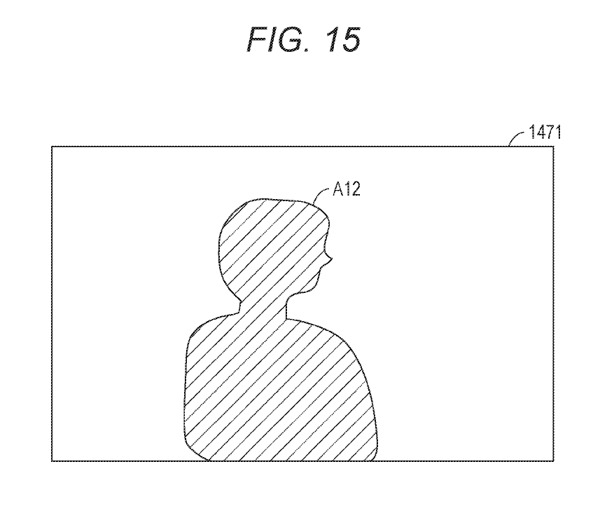

FIG. 15 is a diagram of a region blocked on the screen 1471 by the avatar seated on the seat 1456 according to at least one embodiment of this disclosure. In FIG. 15, the front side of the screen 1471 is shown. A region A12 represents the region occupied on the screen 1471 by the region A11 in FIG. 14. The region other than the region A12 on the screen 1471 corresponds to, of the field of view from the avatar seated on the seat 1451 to the screen 1471, the ratio of the field of view that is maintained even when a new avatar is seated on the seat 1456. For example, when the area of the region A12 occupies 35% of the area of the screen 1471, the ratio of the field of view that is maintained is 65%.

Returning to the state ST12 of FIG. 14, the chat system calculates, for each of the seats 1452 to 1456, the maintained ratio on the screen 1471 of the field of view of the avatar seated on the seat 1451 in the manner described with reference to FIG. 15. The chat system then selects, of the seats 1452 to 1456, the seats having a calculated ratio that exceeds a predetermined value as a recommended seat. In other words, a recommended seat is a seat having, even after a new avatar is arranged on that recommended seat, an occupation ratio by the new avatar in the field of view of the avatar already seated on the seat 1451 of a fixed value or less.

The chat system further displays the selected recommended seats. In the state ST12 of FIG. 14, the seats 1452 to 1455 are colored as the recommended seats. This coloring prompts the user to designate a seat from among the recommended seats. A message designating a seat from among the recommended coordinates may be displayed in the field-of-view image together with, or in place of, the coloring.

While watching the display of the recommended seats, the user designates a seat on which the avatar is to be newly seated. The state ST13 represents a state in which the seat 1452 is designated as a seat on which the avatar is to be newly seated.

[Details of Module Configuration]

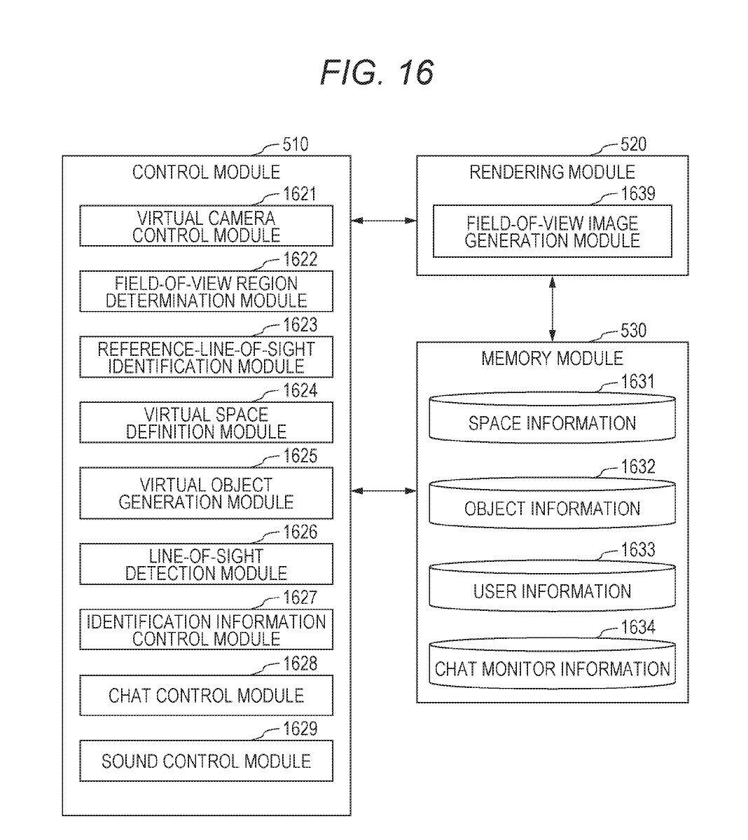

With reference to FIG. 16, a module configuration of the computer 200 are described. FIG. 16 is a block diagram of a configuration of modules of the computer 200 according to at least one embodiment of this disclosure.

In FIG. 16, the control module 510 includes a virtual camera control module 1621, a field-of-view region determination module 1622, a reference-line-of-sight identification module 1623, a virtual space definition module 1624, a virtual object generation module 1625, a line-of-sight detection module 1626, an identification information control module 1627, a chat control module 1628, and a sound control module 1629. The rendering module 520 includes a field-of-view image generation module 1639. The memory module 530 stores space information 1631, object information 1632, user information 1633, and chat monitor information 1634.

In at least one aspect, the control module 510 controls display of an image on the monitor 130 of the HMD 120. The virtual camera control module 1621 arranges the virtual camera 14 in the virtual space 11, and controls, for example, the behavior and direction of the virtual camera 14. The field-of-view region determination module 1622 defines the field-of-view region 15 in accordance with the direction of the head of the user 5 wearing the HMD 120. The field-of-view image generation module 1639 generates a field-of-view image to be displayed on the monitor 130 based on the determined field-of-view region 15. Further, the field-of-view image generation module 1639 generates a field-of-view image based on data received from the control module 510. Data on the field-of-view image generated by the field-of-view image generation module 1639 is output to the HMD 120 by the communication control module 540. The reference-line-of-sight identification module 1623 identifies the line of sight of the user 5 based on the signal from the eye gaze sensor 140.

The sound control module 1629 detects, from the HMD 120, input of a sound signal that is based on utterance of the user 5 into the computer 200. The sound control module 1629 assigns the sound signal corresponding to the utterance with an input time of the utterance to generate sound data. The sound control module 1629 transmits the sound data to a computer used by a user who is selected by the user 5 among the other computers 200A and 200B in the state of being capable of communicating to/from the computer 200 as chat partners of the user 5.

The control module 510 controls the virtual space 11 to be provided to the user 5. First, the virtual space definition module 1624 generates virtual space data representing the virtual space 11, to thereby define the virtual space 11 in the HMD set 110.

The virtual object generation module 1625 generates data on objects to be arranged in the virtual space 11. For example, the virtual object generation module 1625 generates data on avatar objects representing the respective other users 5A and 5B, who are to chat with the user 5 via the virtual space 11. Further, the virtual object generation module 1625 may change the line of sight of the avatar object of the user based on the lines of sights detected in response to utterance of the other users 5A and 5B.

The line-of-sight detection module 1626 detects the line of sight of the user 5 based on output from the eye gaze sensor 140. In at least one aspect, the line-of-sight detection module 1626 detects the line of sight of the user 5 at the time of utterance of the user 5 when such utterance is detected. Detection of the line of sight is implemented by a known technology, for example, non-contact eye tracking. As an example, as in the case of the limbus tracking method, the eye gaze sensor 140 may detect motion of the line of sight of the user 5 based on data obtained by radiating an infrared ray to eyes of the user 5 and photographing the reflected light with a camera (not shown). In at least one aspect, the line-of-sight detection module 1626 identifies each position that depends on motion of the line of sight of the user 5 as coordinate values (x, y) with a certain position on a display region of the monitor 130 serving as a reference point.

[Presentation of Identification Information]

The identification information control module 1627 controls the presentation of identification information on the avatar objects presented in the virtual space 11. For example, in at least one aspect, the identification information control module 1627 detects, based on an output from the eye gaze sensor 140, that the line of sight of the user 5 is directed at an avatar object presented in the virtual space 11. The identification information control module 1627 presents identification information on other users (e.g., users 5A and 5B) corresponding to the avatar objects. The identification information includes, for example, the names, handle names, and the like of those other users, and other information for distinguishing from other users.

In at least one aspect, the identification information control module 1627 presents an object representing the identification information such that the object faces the viewpoint of the user 5 independently of the direction of the avatar object. For example, the identification information control module 1627 outputs to the monitor 130 data for rendering an image representing the identification information such that the image faces the front of the user 5. This enables the user 5 to easily grasp the user who is using the avatar object.

In at least one aspect, the identification information control module 1627 measures the time that has elapsed since the identification information was presented. When the elapsed time exceeds a time determined in advance (e.g., several seconds), the identification information control module 1627 ends the presentation of the identification information. In this way, the identification information recognized by the user 5 is not continuously presented in the virtual space 11, and as a result, prevention of the other objects arranged in the virtual space 11 becoming difficult to see is avoided.

In at least one aspect, after the identification information on the other users 5A and 5B has been deleted, the identification information control module 1627 may detect, based on the output from the eye gaze sensor 140, that the line of sight of the user 5 is again directed at the avatar objects of the other users 5A and 5B. In this case, the identification information control module 1627 does not again present the identification information on the other users 5A and 5B. The user 5 has already recognized the other users 5A and 5B, and increased complexity caused by unnecessary identification information being presented again in the virtual space 11 is prevented.

In at least one aspect, the identification information control module 1627 may present on the HMD 120 the mode of presenting the avatar objects for which identification information on the other users 5A and 5B has already been displayed in a different mode from the mode of presenting the avatar objects for which identification information has not been presented. In this way, the user 5 may easily distinguish the avatar objects for which identification information has been already presented from the other avatar objects.

In at least one aspect, the identification information control module 1627 may detect movement of the avatar objects in the virtual space 11 based on a signal transmitted from the server 600. For example, the other users 5A and 5B may move their avatar objects by operating their right controller 300. In such a case, the virtual object generation module 1625 presents the avatar objects at the places of those movement destinations. The identification information control module 1627 presents the identification information in the vicinity of the moved avatar objects. In this way, during the presentation of the identification information, even when the places of the avatar objects corresponding to the users have changed in the virtual space 11, each piece of identification information is presented in the vicinity of the avatar object in accordance with the motion of the other users 5A and 5B. The user 5 may accurately identify the other users 5A and 5B without overlooking the correspondence between the identification information and the avatar objects.

In at least one aspect, the identification information control module 1627 detects, based on a signal received from the server 600, that communication to/from another user 5A or user 5B is cut off. Communication may be cut off, for example, when the communication line is unstable, when the radio waves used in the mobile communication network are interrupted, when a power outage occurs, or the like. The identification information control module 1627 may end the presentation of the avatar object and the identification information in response to communication being cut off. The identification information control module 1627 may present the avatar object in the virtual space 11 when, based on a signal received from the server 600, communication to/from the cut-off other users is detected as having been re-established.

When the time from when communication is cut off until when communication is re-established is less than a time determined in advance, the identification information control module 1627 may again present the avatar object and the identification information. In a case in which communication is cut off in a state in which the identification information is presented, when the cut-off duration is short, the user 5 may easily grasp the other user who is using the avatar object by again visually recognizing the avatar object and the identification information.

On the other hand, in a case in which the duration that communication is cut off is long, when the avatar object is again presented in the virtual space 11, the user 5 may not visually recognize that avatar object. In this case, the identification information control module 1627 may again present the identification information again in the vicinity of the avatar object when the user 5 has again visually recognized the avatar object.

In at least one aspect, the identification information control module 1627 may present the identification information on the other users 5A and 5B in the virtual space 11 only when the other users 5A and 5B permit the presentation of the identification information. For example, at the time of user registration of a VR chat, each user desiring registration may set whether personal information may be disclosed. A user who does not desire personal information, such as his or her real name, photo, or the like, to be disclosed may register in the server 600 a setting for prohibiting disclosure of personal information. In such a case, that user can enjoy a VR chat in the chat room with only his or her avatar object without disclosing personal information. Therefore, when a specific user has set such a setting, the identification information control module 1627 does not display the identification information even when the user 5 continues to look at the avatar object.

The chat control module 1628 controls communication via the virtual space. In at least one aspect, the chat control module 1628 reads a chat application from the memory module 530 based on operation by the user 5 or a request for starting a chat transmitted by another computer 200A, to thereby start communication via the virtual space 11. When the user 5 inputs a user ID and a password into the computer 200 to perform a login operation, the user 5 is associated with a session (also referred to as “room”) of a chat as one member of the chat via the virtual space 11. After that, when the user 5A using the computer 200A logs in to the chat of the session, the user 5 and the user 5A are associated with each other as members of the chat. When the chat control module 1628 identifies the user 5A of the computer 200A, who is to be a communication partner of the computer 200, the virtual object generation module 1625 uses the object information 1632 to generate data for presenting an avatar object corresponding to the user 5A, and outputs the data to the HMD 120. When the HMD 120 displays the avatar object corresponding to the user 5A on the monitor 130 based on the data, the user 5 wearing the HMD 120 recognizes the avatar object in the virtual space 11.

In at least one embodiment, the chat control module 1628 waits for input of sound data that is based on utterance of the user 5 and input of data from the eye gaze sensor 140. When the user 5 performs an operation (e.g., operation of controller, gesture, selection by voice, or gaze by line of sight) for selecting an avatar object in the virtual space 11, the chat control module 1628, based on the operation, detects the fact that the user (e.g., user 5) corresponding to the avatar object is selected as the chat partner. When the chat control module 1628 detects utterance of the user 5, the chat control module 1628 transmits sound data that is based on a signal transmitted by the microphone 170 and eye tracking data that is based on a signal transmitted by the eye gaze sensor 140 to the computer 200A via the communication control module 540 based on a network address of the computer 200A used by the user 5A. The computer 200A updates the line of sight of the avatar object of the user 5 based on the eye tracking data, and transmits the sound data to the HMD 120A. When the computer 200A has a synchronization function, the line of sight of the avatar object is changed on the monitor 130 and sound is output from the speaker 115 substantially at the same timing, and thus the user 5A is less likely to feel strange.

The space information 1631 stores one or more templates that are defined to provide the virtual space 11.

The object information 1632 stores data for displaying an avatar object to be used for communication via the virtual space 11, content to be reproduced in the virtual space 11 and information for arranging an object to be used in the content. The content may include, for example, game content and content representing landscapes that resemble those of the real society. The data for displaying an avatar object may contain, for example, image data schematically representing a communication partner who is established as a chat partner in advance, and a photo of the communication partner.

The user information 1633 stores, for example, a program for causing the computer 200 to function as a control device for the HMD set 110, an application program that uses each piece of content stored in the object information 1632, and a user ID and a password that are required to execute the application program. The data and programs stored in the memory module 530 are input by the user 5 of the HMD 120. Alternatively, the processor 210 downloads programs or data from a computer (e.g., server 600) that is managed by a business operator providing the content, and stores the downloaded programs or data into the memory module 530.

The chat monitor information 1634 includes information on the communication via the virtual space 11 shared between the computer 200 and the other computers 200A and 200B. The chat monitor information 1634 includes, for example, identification information on each user participating in the chat using the virtual space 11, a login status of each user, data for controlling whether presentation of the identification information is permitted, the date and time that the identification information was presented last, and the like.

In at least one aspect, when each user logs in to a chat room prepared for VR chat in advance, information on the user who has logged in is transmitted to the computers used by the other users who are logged in to the chat room. For example, when the users 5A and 5B each log in to the chat room, the user IDs, identification information, and login status (e.g., “logged in”) of the users 5A and 5B and whether the identification information on the users 5A and 5B may be presented are transmitted to the computer 200 of the user 5.

<3. Operation Between Computers Through Communication Between Two Users>

Now, a description is given of operation of the computers 200 and 200A at the time when the two users 5 and 5A communicate to/from each other via the virtual space 11. In the following, a description is given of a case in which the user 5A wearing the HMD 120A connected to the computer 200A utters sound toward the user 5 wearing the HMD 120 connected to the computer 200.

(Transmission Side)

In at least one aspect, the user 5A wearing the HMD 120A utters sound toward the microphone 170 in order to chat with the user 5. The sound signal of the utterance is transmitted to the computer 200A connected to the HMD 120A. The sound control module 1629 converts the sound signal into sound data, and associates a timestamp representing the time of detection of the utterance with the sound data. The timestamp is, for example, time data of an internal clock of the processor 210. In at least one aspect, time data on a time when the communication control module 540 converts the sound signal into sound data is used as the timestamp.

When the user 5A is uttering sound, motion of the line of sight of the user 5A is detected by the eye gaze sensor 140. The result (eye tracking data) of detection by the eye gaze sensor 140 is transmitted to the computer 200A. The line-of-sight detection module 1626 identifies each position (e.g., position of pupil) representing a change in line of sight of the user 5A based on the detection result.

The computer 200A transmits the sound data and the eye tracking data to the computer 200. The sound data and the eye tracking data are first transmitted to the server 600. The server 600 refers to a destination of each header of the sound data and the eye tracking data, and transmits the sound data and the eye tracking data to the computer 200. At this time, the sound data and the eye tracking data may arrive at the computer 200 at different timings.

(Reception Side)

The computer 200 receives the data transmitted by the computer 200A from the server 600. In at least one aspect, the processor 210 of the computer 200 detects reception of the sound data based on the data transmitted by the communication control module 540. When the processor 210 identifies the transmission source (i.e., computer 200A) of the sound data, the processor 210 serves as the chat control module 1628 to cause a chat screen to be displayed on the monitor 130 of the HMD 120.

The processor 210 further detects reception of the eye tracking data. When the processor 210 identifies a transmission source (i.e., computer 200A) of the eye tracking data, the processor 210 serves as the virtual object generation module 1625 to generate data for displaying the avatar object of the user 5A.

In at least one aspect, the processor 210 may receive eye tracking data before reception of sound data. In this case, when detecting the transmission source identification number from the eye tracking data, the processor 210 determines that there is sound data transmitted in association with the eye tracking data. The processor 210 waits to output data for displaying an avatar object until the processor 210 receives sound data containing the same transmission source identification number and time data as the transmission source identification number and time data contained in the eye tracking data.

Further, in at least one aspect, the processor 210 may receive sound data before reception of eye tracking data. In this case, when detecting the transmission source identification number from the sound data, the processor 210 determines that there is eye tracking data transmitted in association with the sound data. The processor 210 waits to output the sound data until the processor 210 receives eye tracking data containing the same transmission source identification number and time data as the transmission source identification number and time data contained in the sound data.

In each aspect described above, pieces of time data to be compared may not completely indicate the same time.

When confirming reception of sound data and eye tracking data containing the same time data, the processor 210 outputs the sound data to the speaker 180, and outputs, to the monitor 130, data for displaying an avatar object in which the change that is based on the eye tracking data is translated. As a result, the user 5 can recognize the sound uttered by the user 5A and the avatar at the same timing, and thus can enjoy a chat without feeling a time lag (e.g., deviation between change in avatar object and timing of outputting sound) due to delay of signal transmission.

In the same manner as in the processing described above, the processor 210 of the computer 200A used by the user 5A can also synchronize the timing of outputting sound data and the timing of outputting an avatar object in which the movement of the line of sight of the user 5 is translated. As a result, the user 5A can also recognize output of the sound uttered by the user 5 and the change in avatar object at the same timing, and thus can enjoy a chat without feeling a time lag due to delay of signal transmission.

<4. Server>

A supplementary description is now given of the server 600 in at least one embodiment with reference to FIG. 9. The programs stored in the storage 630 include a program for adjusting the virtual space to be provided in each HMD set 110 of the matching system in accordance with input in another HMD set 110. The storage 630 includes a chat information storage for storing chat monitor information and object information, which are described later.

<5. Control Structure>

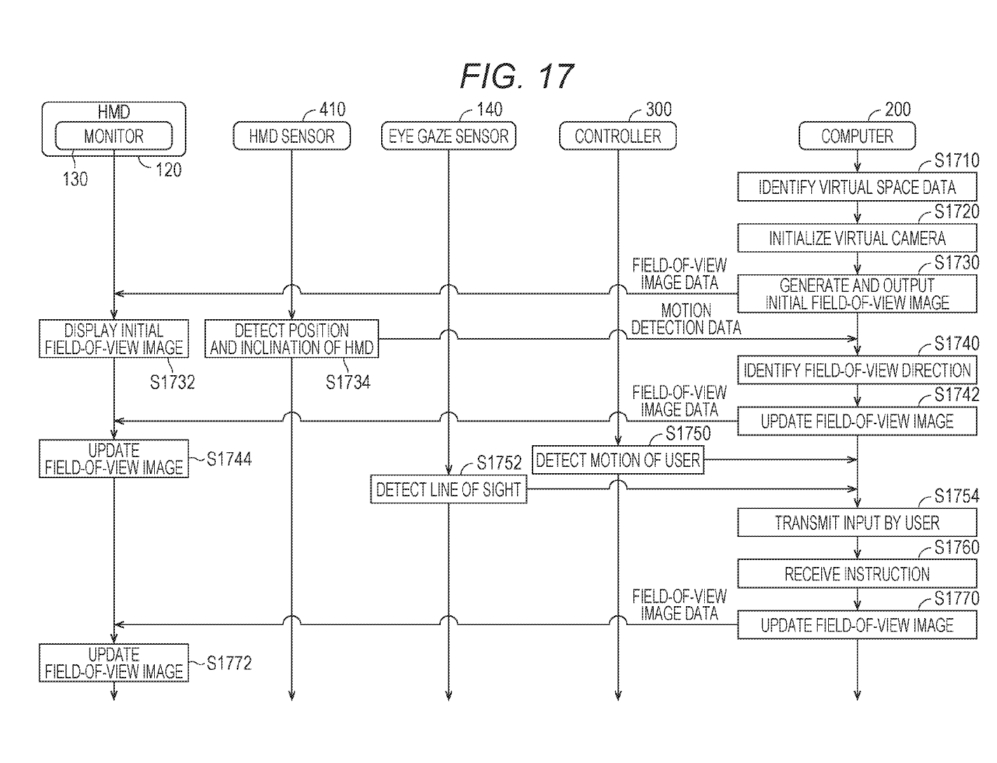

The control structure of the HMD set 110 is now described with reference to FIG. 17. FIG. 17 is a sequence chart of processing to be executed in the HMD set 110 according to at least one embodiment of this disclosure.

In Step S1710, the processor 210 of the computer 200 serves as the virtual space definition module 1624 to identify the virtual space data.

In Step S1720, the processor 210 initializes the virtual camera 14. For example, the processor 210 arranges the virtual camera 14 at a central point defined in advance in the virtual space 11, and directs the line of sight of the virtual camera 14 in the direction in which the user 5 is facing.

In Step S1730, the processor 210 serves as the field-of-view image generation module 1639 to generate field-of-view image data for displaying an initial field-of-view image. The generated field-of-view image data is transmitted to the HMD 120 by the communication control module 540 via the field-of-view image generation module 1639.

In Step S1732, the monitor 130 of the HMD 120 displays the field-of-view image based on the signal received from the computer 200. The user 5 wearing the HMD 120 may recognize the virtual space 11 by visually recognizing the field-of-view image.

In Step S1734, the HMD sensor 410 detects the position and inclination of the HMD 120 based on a plurality of infrared rays emitted from the HMD 120. The detection result is transmitted to the computer 200 as motion detection data.

In Step S1740, the processor 210 identifies, based on the position and inclination of the HMD 120, the field-of-view direction of the user 5 wearing the HMD 120. The processor 210 executes an application program and causes the object to be displayed in the virtual space 11 based on a command included in the application program. The user 5 enjoys visually recognizable content in the virtual space 11 as a result of the execution of the application program. In at least one aspect, the content may be a matchmaking application. In the matchmaking application, two or more avatars are displayed, and input of designating one or more avatars of the two or more avatars is received. The matchmaking application transmits the designated input to the server 600. The server 600 matches two or more users among a plurality of users based on input from the matchmaking application executed by each of the plurality of users.

In Step S1742, the processor 210 updates the field-of-view image based on the determined state of the virtual users. Then, the processor 210 outputs to the HMD 120 data (field-of-view image data) for displaying the updated field-of-view image.

In Step S1744, the monitor 130 of the HMD 120 updates the field-of-view image based on the received field-of-view image data, and displays the updated field-of-view image.

In Step S1750, the controller 300 detects an operation by the user 5. A signal indicating the detected operation is transmitted to the computer 200. The signal includes an operation of designating one or more avatars among two or more displayed avatars. More specifically, the signal includes an operation of displaying a virtual hand and indicating a motion in which the virtual hand touches one or more avatars among two or more of the displayed avatars.

In Step S1752, the eye gaze sensor 140 detects the line of sight of the user 5. A signal indicating a detection value of the detected line of sight is transmitted to the computer 200. In this disclosure, placing the point of gaze on the avatar is also treated as “designating the avatar”.

Specifically, in at least one embodiment, when the user 5 touches an avatar with his or her virtual hand by operating the controller 300 and/or when the user places his or her point of gaze on the avatar, the computer 200 treats such an action as designating the avatar.

In Step S1754, the processor 210 transmits to the server 600 input indicating that the virtual user has designated the avatar.

The server 600 receives from the processor 210 of each computer 200 input regarding which user in the virtual space each virtual user has designated. Then, based on the fact that the inputs satisfy a predetermined condition, the server 600 matches two or more of the plurality of users participating in the matching system. The server 600 transmits a predetermined instruction to the processor 210 of each computer 200 used by the matched users.

In Step S1760, the processor 210 receives a predetermined instruction from the server 600.

In Step S1770, the processor 210 updates a field-of-view screen in accordance with the instruction from the server 600, and outputs to the HMD 120 data (field-of-view image data) for displaying the updated field-of-view image.

In Step S1772, the monitor 130 of the HMD 120 updates the field-of-view image based on the received field-of-view image data, and displays the updated field-of-view image.

<6. Data Structure>

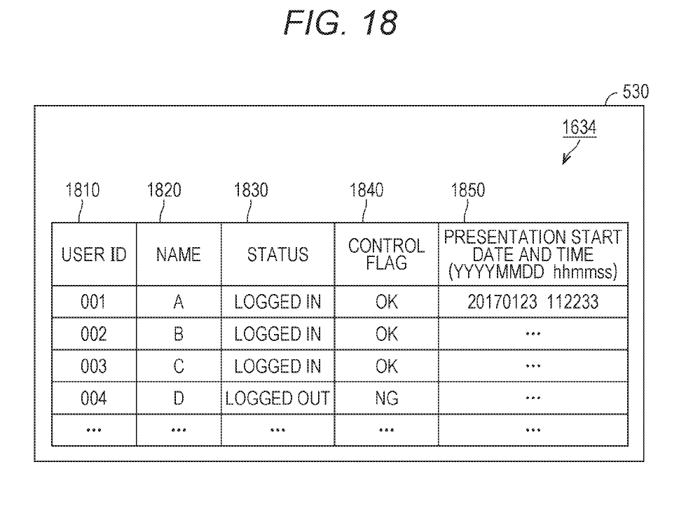

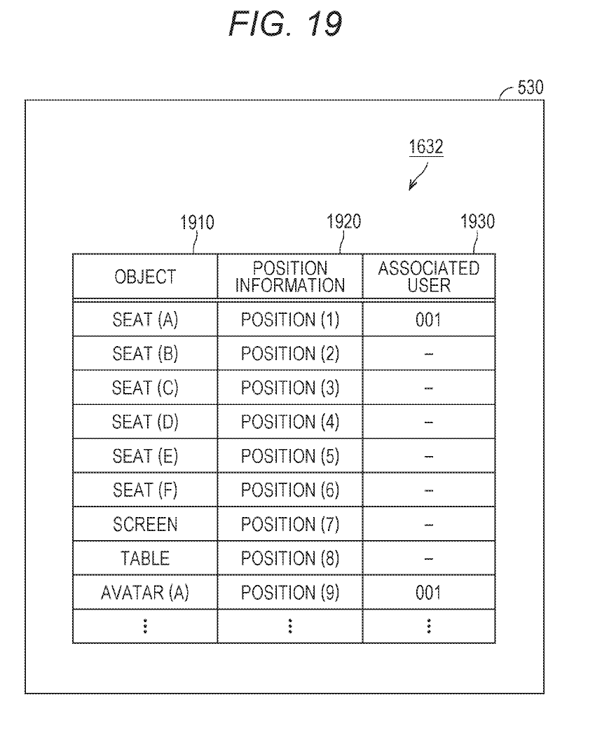

The data structure of the memory module 530 is now described with reference to FIG. 18 and FIG. 19. The chat monitor information and the object information shown in FIG. 18 and FIG. 19 may also be stored in the chat information storage of the server 600, for example, by transmitting such information from each computer 200 to the server 600.

[Chat Monitor Information]

FIG. 18 is a diagram of a mode of storage of chat monitor information in the memory module 530 according to at least one embodiment of this disclosure. In at least one aspect, the memory module 530 stores chat monitor information 1634. The chat monitor information 1634 includes a user ID 1810, a name 1820, a status 1830, a control flag 1840, and a presentation start date and time 1850.

The user ID 1810 is used by the computer 200 for identifying the users sharing the virtual space 11. The name 1820 is used for notifying each user sharing the virtual space 11. For example, the name 1820 may be one of a real name or a pen name of the user. The status 1830 indicates the login state in a chat room opened by the user in the virtual space 11. The control flag 1840 controls whether the identification information (e.g., real name or pen name) on the user is permitted to be presented to other users. The presentation start date and time 1850 represents the date and time at a time when the identification information on the user was first presented in a given session of the chat room opened in the virtual space 11. In at least one aspect, the presentation start date and time 1850 is reset each time the chat session ends. Therefore, when the presentation condition of the identification information is satisfied again in the next session, the identification information may be newly presented even to users to which the identification information has already been presented.

[Object Information]

FIG. 19 is a diagram of a mode of storage of object information in the memory module 530 according to at least one embodiment of this disclosure. In at least one aspect, the memory module 530 stores object information 1632. The object information 1632 includes an object ID 1910, position information 1920, and an associated user ID 1930.

The object ID 1910 is used by the computer 200 to identify the objects arranged in the chat room. For example, “Seats (A)” to “Seats (F)” of FIG. 19 correspond to the seats 1451 to 1456 of FIG. 14, respectively. The “Screen” of FIG. 19 corresponds to the screen 1471 of FIG. 14. The “Table” of FIG. 19 corresponds to the table 1472 of FIG. 14.

The position information 1920 is used by the computer 200 to identify the position of each object in the virtual space.

The associated user ID 1930 is used by the computer 200 to identify the user with which each object is associated. In the example of FIG. 19, the Seat (A) and the avatar (A) are associated with the user identified by the ID “001”. In an example of associating a user with an object, an avatar corresponding to the user A is displayed, and when that avatar sits on a seat, the avatar and the seat are associated with the user A.

<7. Processing Flow>

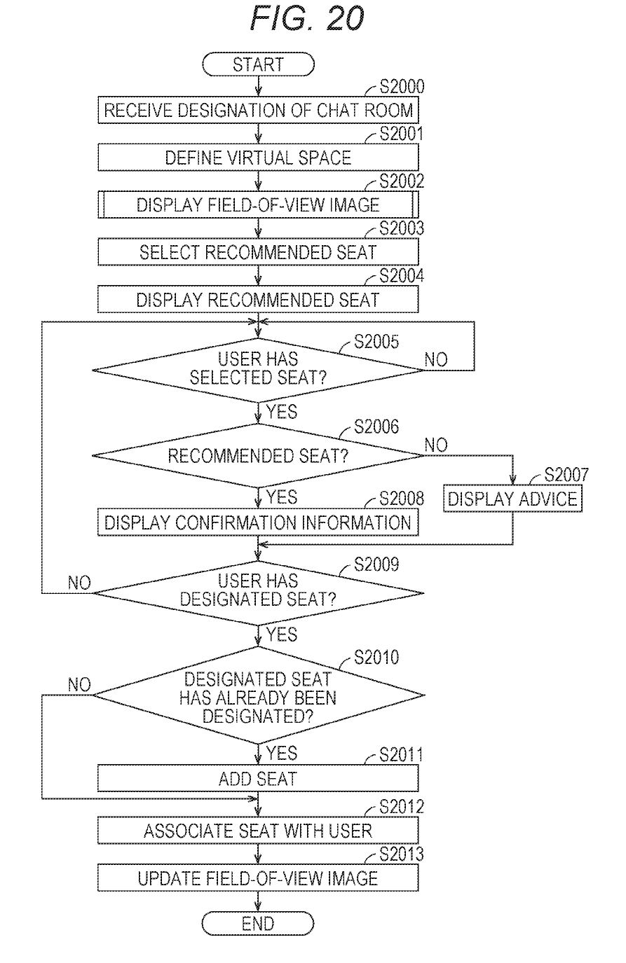

Setting of the seats in the chat system is now described with reference to FIG. 20 to FIG. 27.

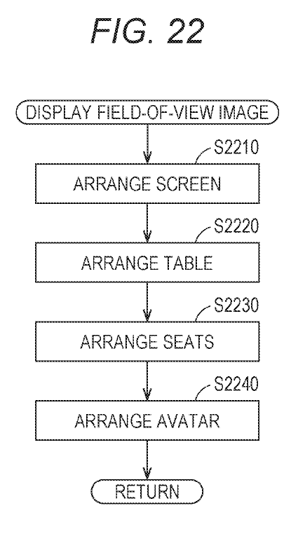

FIG. 20 is a flowchart of processing to be executed by the processor 210 of the computer 200 according to at least one embodiment of this disclosure. In the computer 200, the processing in FIG. 20 (and FIG. 22 described later) is implemented by the processor 210 executing a given program according to at least one embodiment.

In the processing of FIG. 20, the computer 200 presents recommended seats to the user. After selecting a seat, the user designates the seat by confirming the selection. In at least one embodiment, “selection” of a seat by the user means to provisionally confirm the seat, and “designation” of the seat by the user means to finally confirm the seat. The seat to be associated with the user is identified by a two-step process, namely, “selection” by the user and “designation” by the user.

When the user designates a seat, the computer 200 updates the field-of-view image such that a new avatar is seated on the designated seat. The content of the processing is now described in detail with reference to FIG. 20.

In FIG. 20, in Step S2000, the processor 210 receives a designation of a chat room. In Step S2001, the processor 210 defines a virtual space for displaying the designated chat room. In Step S2002, the processor 210 displays a field-of-view image representing the designated chat room.

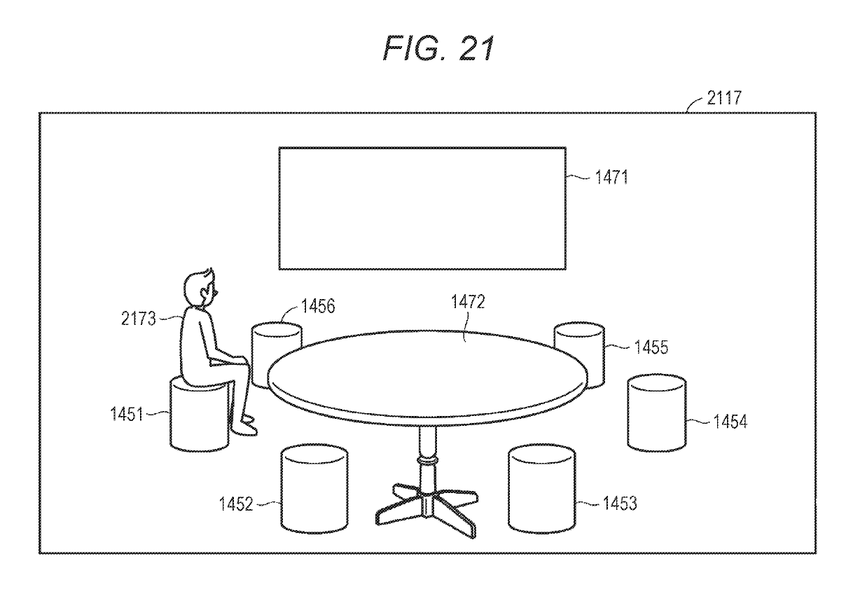

FIG. 21 is a diagram of a field-of-view image representing a chat room according to at least one embodiment of this disclosure. A field-of-view image 2117 of FIG. 21 includes a screen 1471, a table 1472, six seats 1451 to 1456, and an avatar 2173. The avatar 2173 represents the user associated with the seat 1451. The avatar 2173 is seated on the seat 1451.

FIG. 22 is a flowchart of a subroutine of the control of Step S2002 of FIG. 20 according to at least one embodiment of this disclosure. The content of the subroutine of Step S2002 is now described with reference to FIG. 22.

In Step S2210, the processor 210 arranges a screen in the chat room. As a result, the screen 1471 of FIG. 21 is arranged in the chat room.

In Step S2220, the processor 210 arranges a table in the chat room. As a result, the table 1472 of FIG. 21 is arranged in the chat room.

In Step S2230, the processor 210 arranges seats in the chat room. As a result, the seats 1451 to 1456 are arranged in the chat room.

In Step S2240, the processor 210 arranges an avatar in the chat room. As a result, the avatar 2173 is arranged in the chat room. There may be cases in which there is no avatar to be controlled in Step S2240. An example of such a case is when there is no user associated with the seats 1451 to 1456 in the chat room. After the control of this step, the processor 210 returns the control to Step S2002 of FIG. 20.

Returning to FIG. 20, in Step S2003, the processor 210 selects recommended seats from the seats included in the field-of-view image displayed in Step S2002. An example of the procedure for selecting the recommended seats is described above with reference to FIG. 14 and FIG. 15. Specifically, even when the avatar is newly seated, the processor 210 selects as the recommended seats the seats having a maintained ratio of the field of view from an avatar already seated on an already-designated seat to the screen 1471 equal to or more than a value determined in advance.

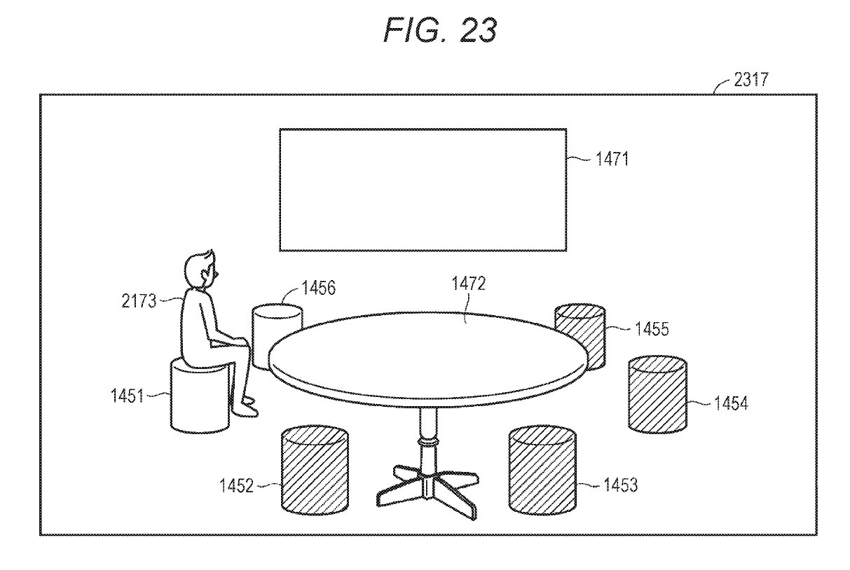

In Step S2004, the processor 210 displays the recommended seats. FIG. 23 is a diagram of an example of the display mode of the recommended seats according to at least one embodiment of this disclosure. In afield-of-view image 2317 of FIG. 23, compared with the field-of-view image 2117 of FIG. 21, four seats 1452, 1453, 1454, and 1455 are colored.

In the example of FIG. 23, the seats 1452, 1453, 1454, and 1455 are indicated to be selected as the recommended seats. Specifically, coloring the seats indicates that those seats are the recommended seats. The display mode of the recommended seats is not limited to the example of FIG. 23. Any display mode may be used as long as information for discriminating whether each seat is a recommended seat is presented.

Returning to FIG. 20, in Step S2005, the processor 210 determines whether at least one seat of the two or more seats in the chat room has been selected by the user. In one example, the processor 210 determines that the user has selected a seat by receiving input of an appropriate signal from any one of the controller 300, the microphone 170, and the eye gaze sensor 140.

The processor 210 keeps the control at Step S2005 (NO in Step S2005) until a determination is made that the user has selected a seat. In response to a determination that the user has selected a seat (YES in Step S2005), the processor 210 advances the control to Step S2006.

In Step S2006, the processor 210 determines whether the seat selected by the user is a recommended seat selected by the processor 210 in Step S2003.

In response to a determination that the seat selected by the user is a recommended seat (YES in Step S2006), the processor 210 advances the control to Step S2008. In response to a determination that the seat selected by the user is not a recommended seat (NO in Step S2006), the processor 210 advances the control to Step S2007.

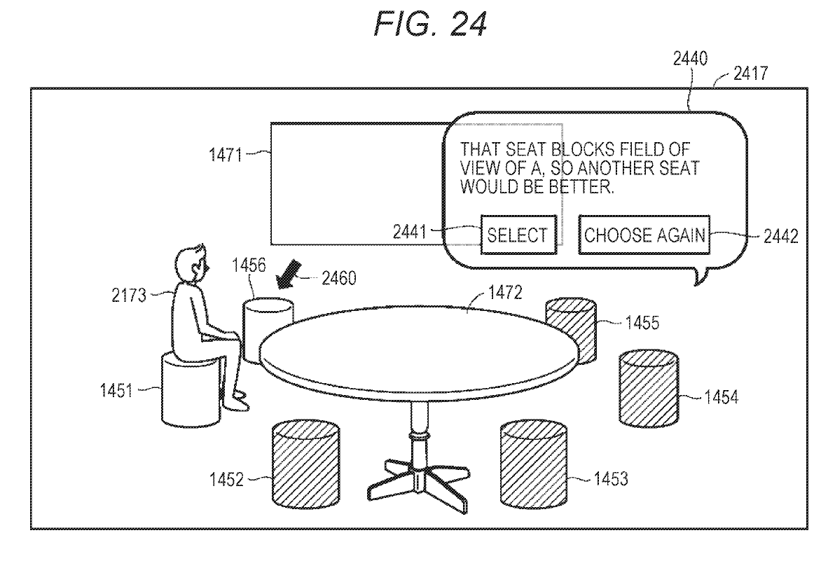

In Step S2007, the processor 210 displays the advice. An example of a display of advice is now specifically described with reference to FIG. 24. FIG. 24 is a diagram of a display of advice according to at least one embodiment of this disclosure.

A field-of-view image 2417 in FIG. 24 includes an arrow 2460 and a message box 2440 in addition to the chat room represented by the field-of-view image 2317 of FIG. 23. The arrow 2460 is an image object pointing to the seat selected by the user (seat 1456 in the example of FIG. 24).

The message box 2440 includes a message “That seat blocks field of view of A, so another seat would be better.” This message prompts the user to avoid designating a seat that is not a recommended seat by prompting the user to select a seat different from an already-designated seat. More specifically, this message is an example of information for prompting the user to avoid designating a seat other than a recommended seat.

The message box 2440 includes buttons 2441 and 2442. The button 2441 is operated in order to designate the currently selected seat as the seat on which the avatar is to be arranged. The button 2442 is operated in order to reselect a seat. The user selects the button 2441 or the button 2442 by operating the controller 300 or the like.

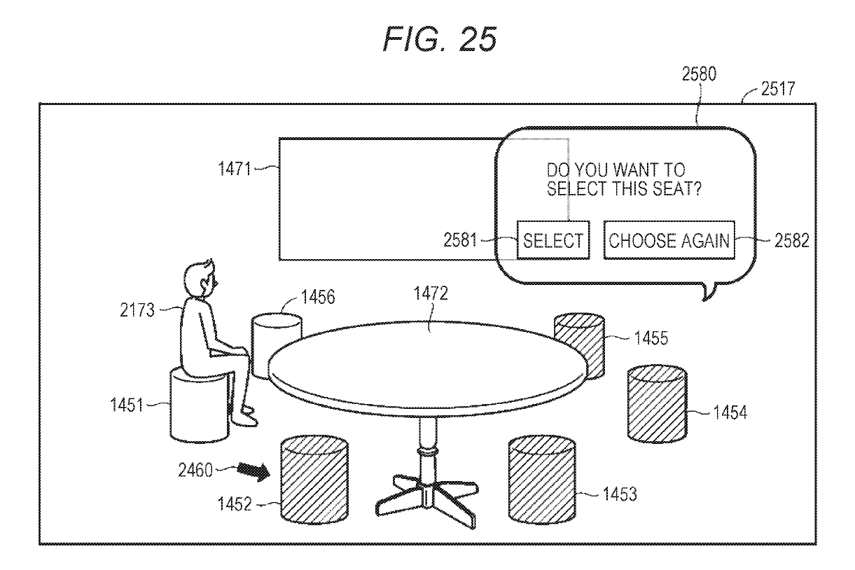

Returning to FIG. 20, in Step S2008, the processor 210 displays confirmation information. An example of a display of the confirmation information is now specifically described with reference to FIG. 25. FIG. 25 is a diagram of an example of a display of confirmation information according to at least one embodiment of this disclosure.

A field-of-view image 2517 of FIG. 25 includes the arrow 2460 and a message box 2580 in addition to the chat room represented by the field-of-view image 2317 of FIG. 23. The arrow 2460 is an image object pointing to the seat selected by the user (seat 1452 in the example of FIG. 25).

The message box 2580 includes a message “Do you want to select this seat?”. The message box 2580 also includes buttons 2581 and 2582. The button 2581 is operated in order to designate the currently selected seat as the seat on which the avatar is to be arranged. The button 2582 is operated in order to reselect a seat. The user selects the button 2581 or the button 2582 by operating the controller 300 or the like.

In Step S2009, the processor 210 determines whether the user has designated the seat that is currently selected. When the user selects the button 2441 of FIG. 24 or the button 2581 of FIG. 25, the processor 210 determines that the user has designated the seat that is currently selected. When the user selects the button 2442 of FIG. 24 or the button 2582 of FIG. 25, the processor 210 determines that the user did not designate the seat that is currently selected.

In response to a determination that the user designated the seat that is currently selected (YES in Step S2009), the processor 210 advances the control to Step S2010. In response to a determination that that the user did not designate the seat that is currently selected (NO in Step S2009), the processor 210 returns the control to Step S2005.

In Step S2010, the processor 210 determines whether the designated seat is a seat that is already associated with another user (already-designated seat). In the object information (FIG. 19), when the ID of any one of the users is registered in the associated user ID for the object ID corresponding to the designated seat, the processor 210 determines that the designated seat is an already-designated seat. When the ID of any one of the users is not registered in the associated user ID for the object ID corresponding to the designated seat, the processor 210 determines that the designated seat is not an already-designated seat.

In response to a determination that the designated seat is an already-designated seat (YES in Step S2010), the processor 210 advances the control to Step S2011. In response to a determination that the designated seat is not an already-designated seat (NO in Step S2010), the processor 210 advances the control to Step S2012.

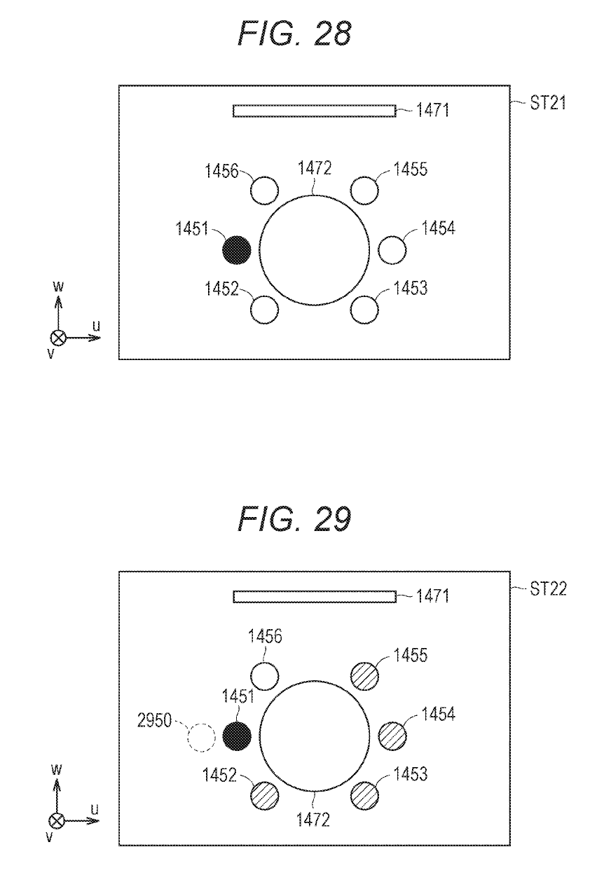

In Step S2011, the processor 210 adds a seat in the vicinity of the already-designated seat. The addition of the seat is described later with reference to FIG. 28 to FIG. 32.

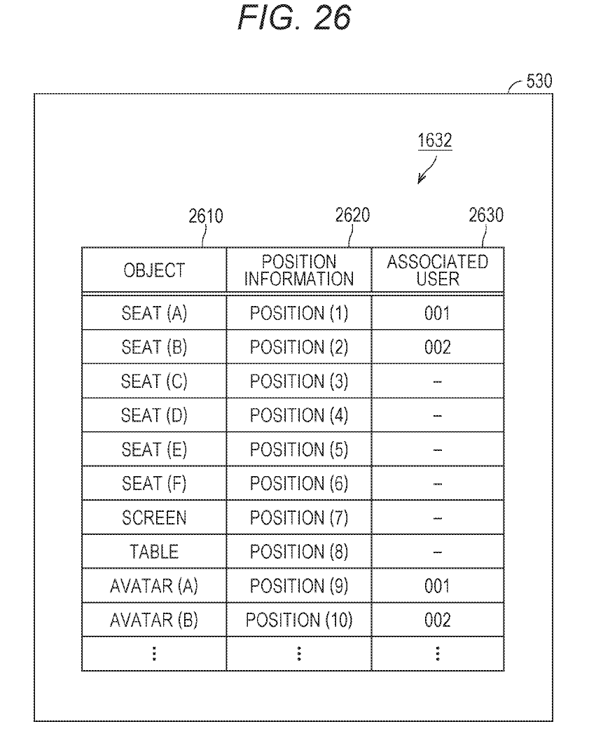

In Step S2012, the processor 210 associates the user of the computer 200 including the processor 210 with the designated seat. As a result, the object information is updated. Updating of the object information is described later with reference to FIG. 26.

In Step S2013, the processor 210 updates the field-of-view image such that an avatar is seated on the designated seat. The avatar is the avatar corresponding to the user of the computer 200 including the processor 210. At this time, the processor 210 updates the object information such that that avatar is associated with the user of the computer 200 including the processor 210.

FIG. 26 is a diagram of object information updated in Step S2012 and Step S2013 according to at least one embodiment of this disclosure.

Compared with the object information of FIG. 19, in the object information of FIG. 26, the associated user ID “002” is associated with the object ID “Seat (B)”. The object ID “Seat (B)” is an example of the “designated seat” in Step S2012, and the associated user ID “002” is an example of “the user of the computer 200 including the processor 210” in Step S2012.

In the object information of FIG. 26, the object ID “Avatar (B)” is added. The object ID “Avatar (B)” is an example of the avatar seated on the “determined seat” in Step S2013.

In the object information of FIG. 26, the associated user ID “002” is associated with the object ID “Avatar (B)”. The associated user ID “002” is an example of “the user of the computer 200 including the processor 210” in Step S2013.

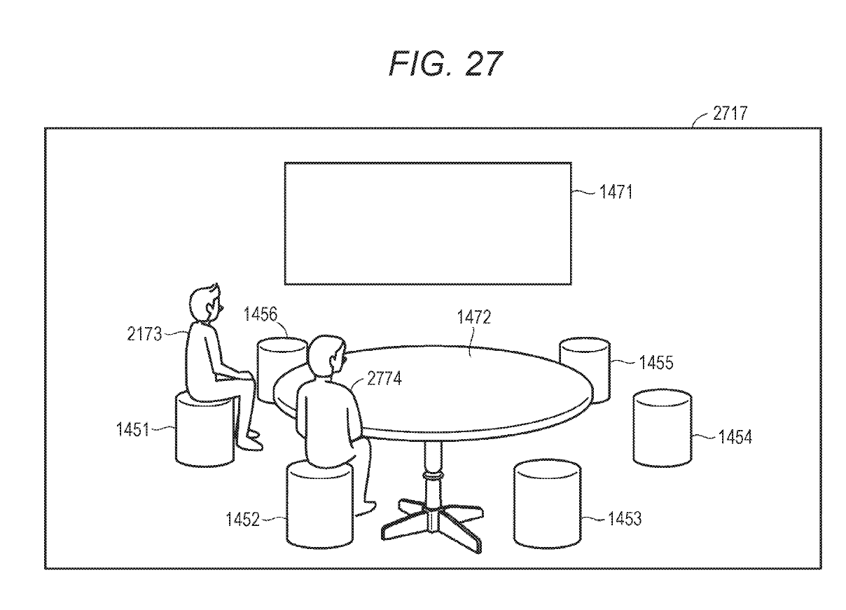

FIG. 27 is a diagram of the field-of-view image updated in Step S2013 according to at least one embodiment of this disclosure. Compared with the field-of-view image 2117 of FIG. 21, a field-of-view image 2717 of FIG. 27 further includes an avatar 2774 seated on the seat 1452. The seat 1452 corresponds to the object information “Seat (B)” of FIG. 26. The avatar 2774 corresponds to the object information “Avatar (B)” of FIG. 26.

<8. Addition of Seat>

The addition of a seat in Step S2010 (FIG. 20) is now described with reference to FIG. 28 to FIG. 32. FIG. 28 to FIG. 32 are diagrams for the addition of a seat to the chat room. In at least the examples of FIG. 28 to FIG. 32, in a situation in which, among the seats 1451 to 1456, the seat 1451 is already associated with another user, the user designates the seat 1451 as the seat on which an avatar is to be newly arranged. The added seat is a seat 2950.

First, the arrangement of the seat to be added in the “vicinity of the designated seat” is described with reference to FIG. 28 and FIG. 29.

In FIG. 28, there is a u axis-w axis plane in a uvw visual field coordinate system according to at least one embodiment of this disclosure. In a state ST21 of FIG. 28, the chat room includes the six seats 1451 to 1456 together with the screen 1471 and the table 1472. As described above, the seat 1451 is already associated with another user. This corresponds to the fact that in FIG. 28, among the seats 1451 to 1456, only the seat 1451 is colored.

In FIG. 29, there is a state ST22 in which a seat has been added to the chat room of FIG. 28. In the state ST22, the seat 2950 is an example of an added seat. The seat 2950 is arranged in the vicinity of the seat 1451. The expression “in the vicinity of” means, for example, a position closer to the seat 1451 than the seats (seats 1452 to 1456) other than the seat 1451. However, the meaning of “in the vicinity of” is not limited to this. In at least one embodiment, the seat 1451 is arranged at a position farther from the table 1472 than the seat 2950.

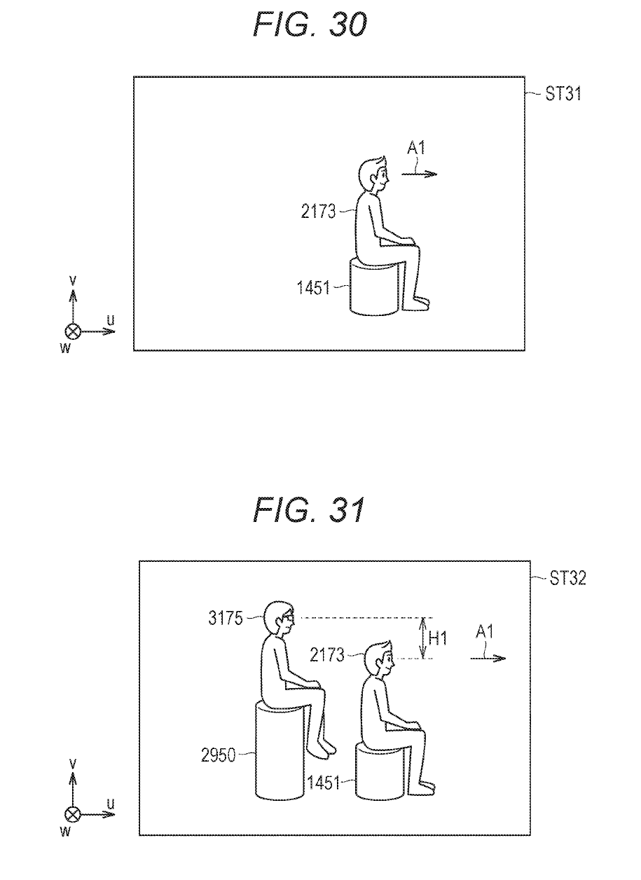

Next, the relationship between the height of the line of sight of the seat designated by the user and the height of the line of sight of the seat to be added at a time when the avatar is seated is described with reference to FIG. 30 and FIG. 31. FIG. 30 is a diagram of a part of the visual-field image for the u axis-v axis plane in the uvw visual field coordinate system according to at least one embodiment of this disclosure. In FIG. 30, there is a state before the seat 2950 of FIG. 29 is added. In a state ST31 of FIG. 30, the avatar 2173 is seated on the seat 1451. An arrow A1 of FIG. 30 represents the direction from the avatar 2173 to the center of the table 1472 (e.g., FIG. 28).

In FIG. 31, there is a state ST32 in which a seat is added to the state ST31 of FIG. 30. The seat surface of the seat 2950 has a different position in the v axis direction from the seat surface of the seat 1451 (e.g., is positioned higher in the virtual space). The line of sight of an avatar 3174 seated on the seat 2950 is positioned higher by a height H1 than the line of sight of the avatar 2173 seated on the seat 1451. As a result, blocking of the field-of-view of the avatar 2173 by the avatar 3174 may be avoided as much as possible.

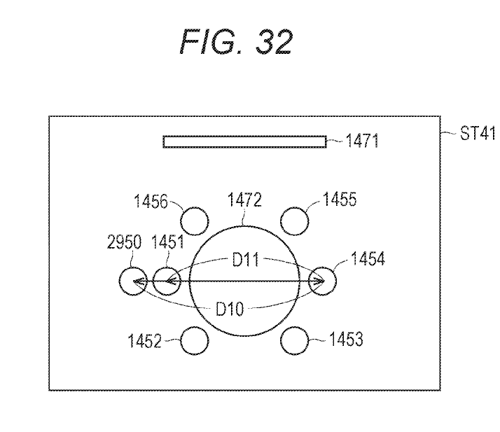

Next, the difference in the positional relationship between the added seat (seat 2950) and the designated seat (seat 1451) with respect to the remaining seats is described with reference to FIG. 32.

In FIG. 32, there is a state ST41 in which, similarly to FIG. 29, the seat 2950 has been added to the chat room. In FIG. 32, there is represented a u axis-w axis plane of the chat room. In the state ST41 of FIG. 32, a distance D10 and a distance D11 each represent the distance between the following seats in the u axis-w axis plane. The distance D10 is longer than the distance D11.

Distance D10: Distance between the seat 2950 and the seat 1454

Distance D11: Distance between the seat 1451 and the seat 1454

In other words, the added seat (seat 2950) is arranged at a place that is farther from a remaining seat (seat 1454) than the designated seat (seat 1451). As a result, a user who selected a seat earlier may be associated with a seat positioned at a place that is closer to another user than to the user who selected the seat later. The seat to be added may be farther from all of the seats already arranged in the chat room, or may be farther from at least a part of those seats.

<9. Determination of Seat by System>

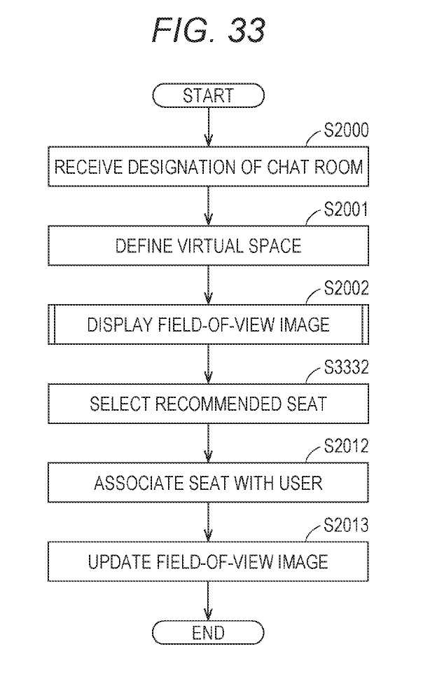

Processing (so-called seat “targeting”) in which a seat selected by the chat system as a recommended seat is automatically set as the seat for an avatar to be newly arranged is now described with reference to FIG. 33. FIG. 33 is a flowchart of processing for designating a seat for an avatar to be newly arranged by a computer according to at least one embodiment of this disclosure. In at least one embodiment, the computer 200 implements the processing of FIG. 33 by, for example, executing an appropriate program by the processor 210.

The processing of FIG. 33 includes, of the processing of FIG. 20, Step S2000, Step S2001, Step S2002, Step S2012, and Step S2013. In the processing of FIG. 33, similarly to the processing of FIG. 20, the processor 210 receives a designation of a chat room in Step S2000, defines a virtual space in Step S2001, and displays a field-of-view image of the designated chat room in Step S2002. Then, the control is advanced to Step S3332.

In Step S3332, the processor 210 selects a number of recommended seats equal to the number of avatars to be arranged. Specifically, the processor 210 selects the recommended seats in the same manner as Step S2003 of FIG. 20, then from those selected recommended seats, extracts in accordance with a condition determined in advance a number of recommended coordinates equal to the number of avatars to be arranged, and outputs the extracted recommended seats. An example of the condition determined in advance is to follow a priority for each seat. For example, when the number of avatars to be arranged is “1”, and the priority associated with the seat 1452 among the seats 1452 to 1455 is high, as the final recommended seat, the processor 210 outputs one seat (e.g., seat 1452) having the highest priority among the recommended seats (e.g., seats 1452 to 1455) selected in the same manner as Step S2003.

In Step S2012, the processor 210 associates the user with the recommended seat finally output in Step S3332. An example of the association between the recommended seat and the user is to update the object information described with reference to FIG. 19 and FIG. 26.

In Step S2013, the processor 210 updates the field-of-view image such that the avatar corresponding to the user of the computer 200 including the processor 210 is seated on the recommended seat finally output in Step S3332. Then, the processing of FIG. 33 ends in at least one embodiment.

When a user enters the chat room based on the above-mentioned processing of FIG. 33, from among the plurality of seats in the chat room, a new avatar is arranged on a seat capable of ensuring that the field-of-view from each avatar seated in a seat already associated with another user to the screen 1471 is of a certain ratio or more. More specifically, the processing of FIG. 33 sets a seat for a new avatar without receiving a selection and designation from the user.

The seat set for the new avatar may be a seat that already exists in the chat room, or may be a seat added as described with reference to FIG. 28 to FIG. 32.

In the processing of FIG. 33, the processor 210 presents a recommended place to the user by displaying an updated field-of-view image in which the avatar is arranged at the recommended place.

<10. Preset Recommended Place>

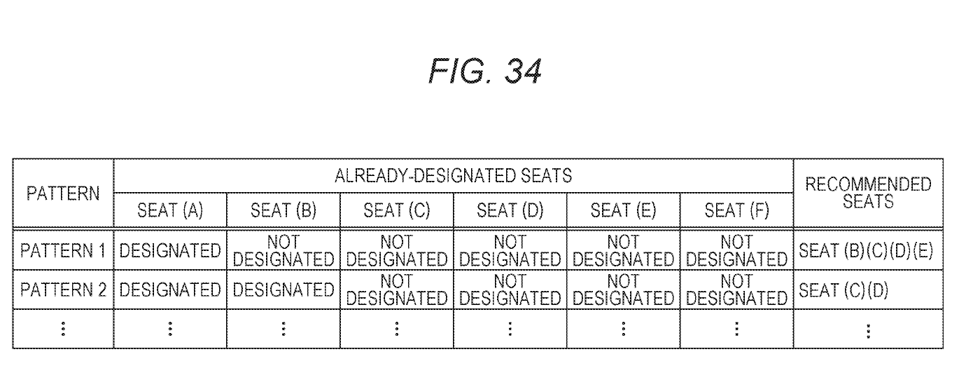

Setting of a seat using a preset recommended place is now described with reference to FIG. 34. FIG. 34 is a diagram of a storage mode of information defining a preset recommended place according to at least one embodiment of this disclosure. The information shown in FIG. 34 is generated by, for example, the creator of the chat application, and is stored as space information 24 in the memory module 530, for example.

As described with reference to FIG. 20, in Step S2003, the processor 210 selects the recommended seats in the manner described with reference to FIG. 14 and FIG. 15. A pattern of the recommended seats may be set as shown in FIG. 34 in advance in accordance with a pattern of the already-designated seats. In Step S2003 of FIG. 20, the processor 210 may select the recommended seats by acquiring the recommended seats of the pattern set in advance.

In the example shown in FIG. 34, the pattern of the already-designated seats and the pattern of the recommended seats are associated with each other. The “Already-Designated Seats” column of FIG. 34 uses the entries “designated” and “not designated” to indicate which of the seats among “Seat (A)” to “Seat (F)” of FIG. 19 is an already-designated seat. The entry “designated” indicates that the seat is an already-designated seat, and the entry “not designated” indicates that the seat is not an already-designated seat.

More specifically, in the “Already-Designated Seats” column of Pattern 1 of FIG. 34, “designated” is shown for “Seat (A)”, and “not designated” is shown for each of “Seat (B)” to “Seat (F)”. Therefore, Pattern 1 indicates that “Seat (A)” is an “already-designated seat” and “Seat (B)” to “Seat (F)” are not “already-designated seats”.

The “Recommended Seats” column of FIG. 34 indicates, from among “Seat (A)” to “Seat (F)” of FIG. 19, “recommended seat” patterns in accordance with the patterns of the already-designated seats shown in the “Already-Designated Seats” column.

More specifically, in the “Recommended Seats” column of Pattern 1 of FIG. 34, “Seats (B) (C) (D) (E)” are shown. As a result, Pattern 1 indicates that “Seat (B)”, “Seat (C)”, “Seat (D)”, and “Seat (E)” of FIG. 19 are the recommended seats.

More specifically, Pattern 1 of FIG. 34 defines that when only “Seat (A)” among “Seat (A)” to “Seat (F)” of FIG. 19 is an already-designated seat, “Seat (B) to “Seat (E)” are to be set as the recommended seats.

In Step S2003 of FIG. 20, the processor 210 extracts the already-designated seats in the virtual space, acquires the recommended seat pattern associated with the pattern of the already-designated seats extracted in FIG. 34, and selects the seats included in the acquired recommended seat pattern as the recommended seats.

Then, the processor 210 advances the control to Step S2004 and subsequent steps in the processing of FIG. 20.

<11. Summary of Disclosure>

This disclosure is summarized as follows.

(1) There is provided an information providing method to be executed on a computer (computer 200) to provide information in a virtual space. The method includes defining (Step S2001) a virtual space (virtual space 11) that is capable of being shared by two or more users. The method further includes arranging (Step S2210 and Step S2220) an object in the virtual space that is capable of being visually recognized by each user. The method further includes defining (Step S2230) in the virtual space a plurality of places that are capable of being designated by each user. The plurality of places include non-designated places (seats 1452 to 1456 of FIG. 21) not associated with any of two or more users, and already-designated places (seat 1451 of FIG. 21) associated with any of two or more users. The information providing method includes selecting (Step S2003 and Step S3332), from among a plurality of places, a recommended place for arranging an avatar. The recommended place is a place in which the avatar occupies a fixed ratio or less of a field-of-view from a designated place to an object when the avatar is arranged at that recommended place (Step S2003 and Step S3332). The information providing method further includes presenting (Step S2004 and Step S2013) information identifying a recommended place as a candidate for arranging the avatar in the virtual space.

Arranging the avatar at the recommended place enables the user who arranged the avatar to arrange the avatar at a place having a low degree of blocking of the field-of-view from a place already associated with another user to the object. As a result, a situation is avoided in which a user who is newly arranging an avatar blocks the field-of-view of the avatar of another user, resulting in deterioration of the relationship with that user. Therefore, at least one embodiment of this disclosure contributes to avoidance of a situation in which human relations between users deteriorate, and as a result contributes to maintaining good human relations between users.

(2) The method may further include receiving (Step S2005) a designation of one or more places from a plurality of places, and providing (Step S2009) a field-of-view image in which the avatar of the user of a head-mounted device connected to the computer is arranged at the place designated from among the plurality of places.

(3) The method may further include outputting (Step S2007) information for prompting identification of the recommended place.

(4) In the method, the information for prompting the designation of the recommended place may include information pointing to the recommended place (coloring of seats 1452 to 1455 in field-of-view image 2317 of FIG. 23).

(5) The information for prompting the designation of the recommended place may include information (message box 2440 of FIG. 24) for prompting avoidance of a designation of a place other than the recommended place among the plurality of places.

(6) The method may further include setting (Step S2011), when the received designation is to select one of the already-designated places, an additional place (seat 2950) associated with the user of the head-mounted device connected to the computer in a vicinity of the already-designated place (seat 1452).

(7) The additional place (seat 2950) may be positioned farther from at least one of the plurality of places than the designated already-designated seat (seat 1452) (FIG. 32).

(8) The method may further include associating (Step S2012 of FIG. 33) the recommended place with the user without receiving a designation of the place to be associated with the user of the head-mounted device connected to the computer.

(9) The method may further include a step (Step S2013 of FIG. 33) of providing a field-of-view image in which the avatar of the user of the head-mounted device connected to the computer is arranged at the recommended place.

In the at least one embodiment described above, the description is given by exemplifying the virtual space (VR space) in which the user is immersed using an HMD. However, a see-through HMD may be adopted as the HMD. In this case, the user may be provided with a virtual experience in an augmented reality (AR) space or a mixed reality (MR) space through output of a field-of-view image that is a combination of the real space visually recognized by the user via the see-through HMD and a part of an image forming the virtual space. In this case, action may be exerted on a target object in the virtual space based on motion of a hand of the user instead of the operation object. Specifically, the processor may identify coordinate information on the position of the hand of the user in the real space, and define the position of the target object in the virtual space in connection with the coordinate information in the real space. With this, the processor can grasp the positional relationship between the hand of the user in the real space and the target object in the virtual space, and execute processing corresponding to, for example, the above-mentioned collision control between the hand of the user and the target object. As a result, an action is exerted on the target object based on motion of the hand of the user.

The above described at least one embodiment of this disclosure disclosed herein is merely an example in all aspects and in no way intended to limit this disclosure. The scope of this disclosure is defined by the appended claims and not by the above description, and it is intended that this disclosure encompasses all modifications made within the scope and spirit equivalent to those of the appended claims. This disclosure described in each of at least one embodiment and modification examples is intended to be implemented independently or in combination to the maximum extent possible.

1. A method, comprising:
defining a virtual space to be shared by a first user and a second user, wherein the virtual space comprises a first object, a viewpoint, a first place, a second place, and a third place;
arranging a second avatar object associated with the second user at the first place in accordance with a designation of the first place by the second user;
identifying a field of view in the virtual space based on a position of the viewpoint;
generating a field-of-view image in accordance with the field of view;
providing the field-of-view image to the first user;
identifying that the second avatar object located at a position other than the second place and the third place;
identifying a first direction from the second place to the first object;
identifying a ratio of the second avatar included in a first field of view, which is identified based on the position of the viewpoint and the first direction, for a case in which the viewpoint is arranged at the second place;
identifying that the ratio is equal to or less than a threshold ratio;
identifying the second place as a recommended place; and
displaying first information for identifying the recommended place in the field-of-view image.

2. The method according to claim 1, further comprising arranging a first avatar object associated with the first user at the second place in accordance with a designation of the second place by the first user.

3. The method according to claim 2, further comprising displaying second information in the field-of-view image,
wherein the second information comprises information for prompting the first user to designate the recommended place.

4. The method according to claim 3, wherein the second information comprises information pointing to the recommended place.

5. The method according to claim 3, further comprising identifying that the third place does not correspond to the recommended place,
wherein the second information comprises information prompting the first user not to designate the third place.

6. The method according to claim 2, further comprising:
receiving a designation by the first user of the first place to which the second user is associated;
introducing a fourth place associated with the first place into the virtual space in accordance with the designation; and
arranging the first avatar object at the fourth place in accordance with the designation of the first place.

7. The method according to claim 6, wherein a distance between the fourth place and the second place or third place is larger than a distance between the first place and the second place or third place.

8. The method according to claim 1, further comprising arranging the first avatar object at the recommended place without receiving a designation of the recommended place by the first user.

9. The method according to claim 8, further comprising arranging the viewpoint at the recommended place.
